(19) United States
(12) Patent Application Publication
(10) Pub. No.: US 2010/0013442 A1
(43) Pub. Date: Jan. 21, 2010

(54) CHARGING SYSTEM, ELECTRONIC CIRCUIT DEVICE INCLUDING SECONDARY CELL, AND POWER SUPPLY DEVICE FOR CHARGING

(75) Inventors: Kazuo Yamazaki, Kanagawa (JP); Yukihiro Terada, Kanagawa (JP); Toshio Nagai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tokyo (JP)

(21) Appl. No.: 12/439,428

(22) PCT Filed: Aug. 28, 2007
(86) PCT No.: PCT/JP2007/066598

§ 371 Date: Feb. 27, 2009

(30) Foreign Application Priority Data
Aug. 30, 2006 (JP) 2006-233652

(51) Int. Cl. H02J 7/04

(52) U.S. Cl. 320/162

(57) ABSTRACT

Provided is a charging system wherein a voltage and a current can be accurately supplied from a power supply device even with a cable wiring resistance and a connector contact resistance, and the power supply device can be commonly used even for a plurality of kinds of electronic circuit devices whereupon different secondary cells are mounted. The charging system is provided with an electronic circuit device (50) having a secondary cell (E2), and a power supply device (10) which can be connected/removed to and from the electronic circuit device and supplies power for charging the secondary cell when connected. In the charging system, a detection signal for charge control is transmitted from the electronic circuit device (50) to the power supply device (10), and the control circuit (12) controls output from an SW power supply circuit (11) based on the detection signal.

### TECHNICAL FIELD

The present invention relates to an electronic circuit device including a secondary cell, a power supply device for charging a secondary cell, and a charging system composed of the electronic circuit device and the power supply device.

### BACKGROUND ART

For example, a piece of set equipment incorporating a secondary cell, such as a portable telephone, generally receives electric power for charging from an AC adaptor to perform the charging of the secondary cell. The AC adaptor controls output by detecting an output voltage and an output current internally.

Since electric power supply by the AC adaptor is performed by a comparatively thin cable, the supply voltage thereof somewhat falls owing to the wiring resistance of the cable and the contact resistance of a connection connector. The conventional charging system using the AC adaptor previously sets the output voltage of the AC adaptor to a value higher than the full charge voltage of the secondary cell by a little accordingly, and generally performs charging by performing a voltage control with a regulator circuit or the like on the side of the set equipment incorporating the secondary cell.

Moreover, although the charging of the secondary cell is generally performed in a constant current mode until the secondary cell becomes a certain voltage, many pieces of small-sized portable set equipment perform the current control in the constant current mode on their AC adaptor sides. Since a transistor for the current control has a relatively large size and the performance of the current control generates a great heat, the performance of the current control on the AC adaptor side brings about an advantage of enabling the more miniaturization of the set equipment.

On the other hand, the optimum charging currents of secondary cells are different from one another according to their types and capacities. The set equipment that performs the current control of the constant current mode on the AC adaptor side thereof has been consequently required to prepare a dedicated AC adaptor to each type of the set equipment for performing constant current output matched to the capacity of the secondary cell.

### DISCLOSURE OF THE INVENTION

### The Problems to be Solved by the Invention

If it is possible to output an accurate voltage from an AC adaptor even if the wiring resistance of a cable and the contact resistance of a connector exist, there is an advantage of enabling the performance of the charging of a secondary cell without proving any regulator circuits on the side of a piece of set equipment. However, the secondary cell such as a lithium ion cell requires to be accurately controlled lest the charging voltage in the constant voltage mode should exceed a prescribed full charge voltage.

Moreover, the set equipment, such as a portable telephone, is now required to use an AC adaptor commonly for make it possible to use the AC adaptor in common among different pieces of set equipment.

On the other hand, the secondary cells to be mounted on the set equipment, such as a portable telephone, are expected to include various types owing to the enhancement of properties and diversification of the set equipment. For example, the set equipment, enabling a user to watch television, is required to enlarge the capacity of the secondary cell thereof, or the set equipment, having the necessity of rapid charging and no necessity of additional functions to be simple in function on the other hand, is not required to enlarge the capacity of the secondary cell thereof so much.

The present invention is directed to provide a charging system capable of supplying an accurate voltage and current from a power supply device even if the wiring resistance of a cable and the contact resistance of a connector exist, and the one capable of performing the charging of a secondary cell without performing any of the voltage control and current control on the side of an electronic circuit device.

Moreover, the present invention is further directed to provide a charging system enabling a plurality of types of electric circuit devices mounted with different secondary cells to use a power supply device in common, and the one capable of realizing a charging operation at a current and voltage suitable to each secondary cell even if a power supply device is commonly used, in a charging system bearing the current control in a constant current mode on the side of the power supply device.

### Means for Solving the Problems

In order to achieve the aforesaid objects, the present invention is configured as follows: a charging system comprises: an electronic circuit device (50 in FIG. 1) including a secondary cell; and a power supply device (10), being connectable and removable against the electronic circuit device, for supplying electric power for charging the secondary cell at the time of being connected to the electronic circuit device, wherein the electronic circuit device transmits a signal for a charging control to the power supply device, and the power supply device controls output of the electric power on the basis of the signal for the charging control.

To put it concretely, it is preferable that the electronic circuit device (50) includes: a charging side detecting circuit (51) detecting a predetermined parameter indicating a charged state of the secondary cell to output a first detected signal; and a control signal line for transmitting the first detected signal to the power supply device at the time of being connected to the power supply device, wherein the power supply device includes: a power supply circuit (11) capable of changing its output; and a control circuit (12) for controlling the output of the power supply circuit on the basis of the first detected signal.

According to the charging system like this, since the predetermined parameter is detected in the neighborhood of the secondary cell, it is possible to make the power supply device output the accurate charging current and charging voltage suitable for the state of the secondary cell. Consequently, it is possible to make the power supply device perform charging at a charging current and charging voltage suitable for the secondary cell even if no regulator circuit is provided on the side of the electronic circuit device.

Furthermore, according to the charging system mentioned above, even if it is achieved to use a power supply device in common in a plurality of types of electronic circuit devices each being mounted with a secondary cell different from one another, an output control is performed on the side of the power supply device on the basis of the signal detected on the side of the electronic circuit device, and consequently it is possible to make the power supply device supply the electric power of the current and voltage suitable for each of the secondary cells.

To put it concretely, the predetermined parameter indicating the charged state is any one of or a plurality of a charging voltage, a charging current, a cell voltage at the time of a temporary charging stop.

Moreover, to put it concretely, it is preferable that the first detected signal is an analog signal; the charging side detecting circuit is configured to displace the first detected signal from a reference value by a predetermined quantity according to a detected value of the parameter; and the control circuit is configured so as to enlarge a power supply output when the first detected signal is the reference value, and so as to reduce the power supply output according to a displacement quantity of the first detected signal from the reference value.

According to the configuration like this, the charging control similar to that of the related art can be realized by the substantially same configuration as that of the related art charging circuit. Moreover, because the detected signal is analogously displaced from the reference value, even if there is a plurality of detected parameters, the output control according to the plurality of parameters can be also realized by adding the respective detected signals together to output the added detected signals to the side of the power supply device.

Desirably, the power supply device (10A in FIG. 3) includes a power supply side detecting circuit (14) for detecting the output voltage and/or the output current to output a second detected signal; and the control circuit (12) is preferably configured to control the output on the basis of the second detected signal when the first detected signal is not input.

Such a configuration enables avoiding the output of a power supply becoming abnormally high or unstable owing to the inexistence of any detected signals when the power supply device is disconnected from the electronic circuit device.

To put it concretely, it is preferable that the control circuit performs a control operation so as to enlarge the power supply output when the first and second detected signals have a reference value, and so as to reduce the power supply output according to the displacement quantity when the first or second detected signal is displaced from the reference value by a certain quantity, the power supply side detecting circuit and the charging side detecting circuit are configured to displace the first or second detected signal from the reference value when the detected voltage exceeds the neighborhood of each of their set voltages, and the set voltage (V1 in FIG. 3) of the power supply side detecting circuit (14) is set to be larger than the set voltage (V2) of the charging side detecting circuit (51).

Furthermore, it is preferable that the power supply side detecting circuit and the charging side detecting circuit are configured so as to displace the first or second detected signal from the reference value when the detected current exceeds the neighborhood of each of their set currents, and the set current (I1 in FIG. 3) of the power supply side detecting circuit (14) is set to be larger than the set current (12) of the charging side detecting circuit (51).

Such configurations make it possible to automatically perform the changes of the detected signals suitably at the time of the connection and removal of the power supply device from the electronic circuit device without providing any configurations for detecting the removal of the power supply device from the electronic circuit device and any configurations for changing the detected signals on the basis of the detection. That is, since a smaller one of the set voltages and the set currents reacts earlier to displace the detected signal greatly in the aforesaid configurations of the detecting circuits, the detected signals on the side of the electronic circuit device operate earlier when the electronic circuit device is connected to the power supply device, and the detected signal on the side of the power supply device does not work until the electronic circuit device is removed from the power supply device. Such configurations can thus change the detected signals suitably.

Moreover, the charging system according to the present invention may be also configured so that the electronic circuit device (50B in FIG. 4) may include: a plurality of charging side voltage detecting units (51a, 51b) for detecting a charging voltage to output voltage detected signals on the basis of a plurality of set voltages having different values from one another; and a first changeover unit (53) for selectively changing any of the voltage detected signals of the plurality of charging side voltage detecting units to transmit the changed voltage detected signal to the power supply device, wherein the power supply device (10B) may include: a plurality of power supply side current detecting units (15a, 15b) for detecting an output current to output current detected signals on the basis of a plurality of set currents having different values from one another; a second changeover unit (17) for selectively changing any of the current detected signals of the plurality of power supply side current detecting units; and a control circuit (12) for performing an output control of supplied electric power, wherein the voltage detected signal and current detected signal that have been changed by the first changeover unit and the second changeover unit, respectively, may be transmitted to the control circuit, which performs the output control on the basis of the transmitted voltage and current detected signals.

Moreover, it is preferable in this case that the power supply device (10B) includes an output voltage detecting unit (16) for detecting an output voltage, and the selective change of the second changeover unit (17) is performed on the basis of a detection result of the output voltage detecting unit.

Moreover, it is preferable that the second changeover unit (17) performs a change to a current detected signal to reduce the output current when the output voltage is high, and performs a change to a current detected signal to enlarge the output current when the output voltage is low.

By such means, the change to a set voltage is performed on the side of the electronic circuit device, and thereby the setting of the maximum current according to the set voltage can be automatically performed. It is possible to realize an efficient charging operation without imposing any burdens on the secondary cell and a charging circuit, for example, by preventing the flow of a large current when the charging voltage is high, and by making a large current flow when the charging voltage is high.

Moreover, the charging system according to the present invention may be configured so that the electronic circuit device (50C in FIG. 5) may include a voltage detecting unit (51v) for detecting a charging voltage to output a first detected signal based on a first set voltage (V2); a current detecting unit (51i) for detecting a charging current to output a second detected signal based on a first set current (12); and an adding circuit (54) for adding the first detected signal and the second detected signal together to output the added first and second detected signals to the side of the power supply device, wherein the power supply device (10C) may include: a voltage detecting unit (14v) for detecting an output voltage to output a third detected signal based on a second set voltage (V1); a current detecting unit (14i) for detecting an output current to output a fourth detected signal based on a second set current (I1); and the control circuit (12) for performing the output control of the supplied electric power, wherein the control circuit performs the output control on the basis of an addition signal of the detected signals transmitted from the electronic circuit device and the third and fourth detected signals.

Moreover, it is preferable in this case that the control circuit performs the output control on the basis of the addition signal when the addition signal is input thereinto, or on the basis of the third and fourth detected signals when the addition signal is not input thereinto.

To put it concretely, the power supply device may include: a signal detecting unit (20 in FIG. 6) for detecting whether the addition signal is input thereinto or not; and a changeover circuit (21) for performing a selective change to the addition signal when the signal detecting unit detects that the addition signal has been input thereinto, or a selective change to the third and fourth detected signals when the signal detecting unit detects that the addition signal has not been input thereinto, to transmit the additional signal or the third and fourth detected signals to the control circuit.

Alternatively, the first set voltage (V2) may be set to be smaller than the second set voltage (V1), and the first set current (I1) may be smaller than the second set current (I1).

By such means, it is possible to suitably supply an optimum charging current and charging voltage according to the secondary cell, and it is also possible to suitably limit a voltage and a current even if the output terminal of the power supply device is connected to a piece of noncompliant electronic equipment or is short-circuited. Moreover, the setting of the set voltages and set currents in the magnitude relations mentioned above enables the realization of the control mentioned above without performing the changeover control of the detected signals.

Moreover, the charging system according to the present invention may be configured so that the electronic circuit device (50D in FIG. 7) may include: a protecting switch (SW1) capable of breaking a current from the power supply device to the secondary cell; a first voltage detecting circuit (51f) for detecting a voltage at a node on the side of the secondary cell from the protecting switch to output a first detected signal; a second voltage detecting circuit (51e in FIG. 7, or 51g in FIG. 10) for detecting a voltage on the side of the power supply device from the protecting switch to output a second detected signal; and a changeover circuit (58) for performing a selective change to the first detected signal when the protecting switch is in its on-state or a selective change to the second detected signal when the protecting switch is in its off-state to transmit the changed detected signal to the power supply device.

Moreover, it is preferable that the second voltage detecting circuit (51g in FIG. 10) is set so as to output a detected signal to control an output voltage to a voltage higher than a cell voltage (Vref) of the secondary cell (E2).

By such means, it becomes possible to detect and control an accurate charging voltage excluding the influences of the voltage drop of the protecting switch, and to stabilize the output of the power supply device by outputting the second detected signal when the protecting switch works and the first detected signal has disappeared. That is, it is avoided by the second detected signal that the output voltage of the power supply device becomes abnormally high.

Moreover, the selection of the second set voltage as described above inputs a voltage higher than the cell voltage into the electric power inputting terminal when the protecting switch is turned off, and enables the prevention of a counter flow of the current from the secondary cell.

Moreover, it is preferable that the power supply device (10F in FIG. 12) includes a timer unit (27) for performing timing on the basis of an input of a detected signal from the electronic circuit device, and the power supply device may be configured to change a state of the power supply output on the basis of a timing result of the timer unit.

By such configuration, it becomes possible to add a timer protection function of, for example, stopping electric power supply when a charging time becomes abnormally longer than an expected time.

Furthermore, it is preferable that the power supply device (10G in FIG. 14) includes a display unit (31) for displaying the charged state of the secondary cell. To put it concretely, it is preferable that the electronic circuit device (50G) is configured to include: a unit (51h, 61) for detecting the charged state of the secondary cell; and a display signal outputting unit (62) for outputting a display signal according to the charged state, wherein the electronic circuit device is configured to enable the display signal outputting unit to transmit the display signal through the control signal line through which the display signal outputting unit outputs the detected signal to the electronic circuit device, wherein the power supply device (10G) includes a display signal detecting circuit (33) detecting the display signal from the control signal line through which the detected signal is transmitted from the electronic circuit device, and the power supply device makes the display unit (31) operate on the basis of the display signal detected by the display signal detecting circuit.

By such a configuration, it becomes possible, for example, to perform a display according to a charging rate, a display for informing a user of charging completion, and the like. The display signal can be made to be, for example, a digital signal, or a modulated signal modulated by a predetermined frequency.

Moreover, it is preferable that the electronic circuit device (50H in FIG. 17) includes a display unit (63) for displaying the charged state of the secondary cell. To put it concretely, it is preferable that the power supply device (10H) includes: a charged quantity calculating unit (38) for calculating a charged quantity of the secondary cell on the basis of the values of the output voltage and output current thereof; a unit (40-43) for giving a predetermined change to the output voltage when a predetermined charged quantity is calculated by the charged quantity calculating unit; and a display signal transmitting unit (39) for transmitting a display signal through the control signal line through which the electronic circuit device transmits the detected signal when the predetermined charged quantity is calculated by the charged quantity calculating unit, wherein the electronic circuit device (50H) includes: a unit (65-67) for temporarily stopping a charging operation on the basis of a predetermined change of an input voltage; and a display signal receiving unit (64) for receiving the display signal during the temporary stop, wherein the electronic circuit device operate the display unit (63) on the basis of the received display signal.

By such a configuration, it is possible to perform a display according to the charging rate and a display of informing a user of charging completion with, for example, the display unit on the side of the electronic circuit device. Moreover, such a configuration has an advantage of enabling the electronic circuit device to display the charged state on its own side even if the electronic circuit device cannot be mounted with any microcomputers and the like in order to achieve the miniaturization and price-reduction thereof and the electronic circuit device cannot perform the detection of the charged state and any display controls on its side.

Moreover, it is preferable that the electronic circuit device (50I in FIG. 19) includes: a switch circuit (SW3) serially connected between an electric power inputting terminal and the secondary cell in series; a signal detecting unit (70) for detecting a detected signal to be output to the power supply device; and a restart unit (71, 74) for detecting a voltage at an electric power inputting terminal to generate a restart signal, wherein the electronic circuit device is configured so that the switch circuit (SW3) may be changed to be off when a magnitude of the detected signal by the signal detecting unit (70) is equal to or less than a predetermined value, and so that the switch circuit (SW3) may be changed to be on when the restart signal is output from the restart unit (74).

By such a configuration, it becomes possible to prevent the counter flow of a current from the secondary cell to the power supply device by turning off the switch circuit even if, for example, the power supply device is disconnected from the plug receptacle or the electric power supply from the power supply device is stopped owing to some defect. Moreover, it is also possible to connect the power supply device to the plug receptacle again and to restart the power supply device for recharging.

Moreover, it is preferable that the electronic circuit device (50J in FIG. 20) includes: a plurality of secondary cells (E2A, E2B) connected to an electric power inputting terminal in parallel; a plurality of switch circuits (77A, 77B) for turning on and off of respective connections between the electric power inputting terminal and the plurality of secondary cells; a plurality of detecting circuits (51A, 51B) for detecting predetermined parameters severally indicating a charged state of each of the plurality of secondary cells to output detected signals on the basis of a set voltage according to each of the secondary cells; and a changeover circuit (79) for selectively outputting any one of the detected signals of the plurality of detecting circuits to the power supply device, wherein the charging system may be configured so that, if any one of the plurality of secondary cells is selected as a charging object, one of the switch circuits corresponding to the selected secondary cell may be made to be in its on-state, and so that the detected signal of one of the detecting circuits corresponding to the selected secondary cell is output from the changeover circuit (79).

By adopting such a configuration, even if an electronic circuit device is mounted with a plurality of secondary cells, the electronic circuit can charge each secondary cell.

Moreover, to put it concretely, it is preferable that the electronic circuit device (50J) includes: a cell holder for holding the plurality of secondary cells in a state of being attachable and detachable; and a detection mechanism (81) for detecting a state of each of the secondary cells in the cell holder with regard to being mounted or not mounted therein, wherein the electronic circuit device may change the secondary cell selected as the charging object according to the detected state by the detection mechanism.

Moreover, to put it concretely, the electronic circuit device (50J) may be configured to comprise a microcomputer (82) to manage the charged state of each of the plurality of secondary cells, wherein the microcomputer changes the charging object to another secondary cell when the secondary cell that is being charged becomes its full charge state.

By such a configuration, it is possible to suitably change the selection of the secondary cell to be a charging object among the plurality of secondary cells.

Incidentally, the reference marks indicating the correspondence relations to the embodiments are described in parentheses in the description of this clause, the present invention is not limited those marked ones.

### EFFECTS OF THE INVENTION

According to the present invention, a charging system connects an electronic circuit device to a power supply device, such as an AC adaptor, to perform charging of a secondary cell. By such a charging system, the present invention has an advantage that, even if the wiring resistance of a cable of a power supply device and the contact resistance of a connection connector exist, an accurate voltage and current according to the charged sate of a secondary cell can be supplied, and that the charging of the secondary cell can be performed without providing any regulator circuits on the side of the electronic circuit device.

Moreover, the present invention has also an advantage of enabling the realization of supplying a suitable current and voltage to each of the secondary cells even if a power supply device is commonly used for a plurality of types of electronic circuit devices mounted with different secondary cells.

### BRIEF DESCRIPTION OF THE DRAWINGS

FIG. 1 is a block diagram showing the basic configuration of the charging system of a first embodiment of the present invention;

FIG. 2A is a graph showing an output characteristic of the charging detecting circuit of FIG. 1;

FIG. 2B is a graph showing another output characteristic of the charging detecting circuit of FIG. 1;

FIG. 3 is a block diagram showing the basic configuration of the charging system of a second embodiment;

FIG. 4 is a block diagram showing the configuration of the charging system of a third embodiment;

FIG. 5 is a block diagram showing the configuration of the charging system of a fourth embodiment;

FIG. 6 is a block diagram showing another configuration example for outputting a detected signal to a control circuit in the fourth embodiment;

FIG. 7 is a block diagram showing the configuration of the charging system of a fifth embodiment;

FIG. 8 is a circuit diagram showing the concrete configurations of a voltage detecting circuit and abnormal voltage detecting circuit of FIG. 7;

FIG. 9 is a characteristic graph for illustrating a detection operation of the abnormal voltage detecting circuit of FIG. 8;

FIG. 10 is a block diagram showing the configuration of the charging system of a sixth embodiment;

FIG. 11 is a graph showing an output characteristic of an AC adaptor of FIG. 10;

FIG. 12 is a block diagram showing the configuration of the charging system of a seventh embodiment;

FIG. 13 is a diagram showing a charging characteristic of a secondary cell;

FIG. 14 is a block diagram showing the configuration of the charging system of an eighth embodiment;

FIG. 15 is a characteristic graph showing a charging operation of the charging system of FIG. 14;

FIG. 16 is a flow chart for illustrating an operation example of the charging system of FIG. 14;

FIG. 17 is a block diagram showing the configuration of the charging system of a ninth embodiment;

FIG. 18 is a timing chart showing a charging stopping time and a transmission and reception time of a display signal in the charging system of FIG. 17;

FIG. 19 is a block diagram showing the configuration of the charging system of a tenth embodiment; and

FIG. 20 is a block diagram showing the configuration of the charging system of an eleventh embodiment.

### EXPLANATION OF REFERENCE NUMERAL

10, 10A-10J AC adaptor
11 SW power supply circuit
12 control circuit
13 signal receiving circuit
14 detecting circuit on AC adaptor side
14i current detecting circuit
14v voltage detecting circuit
15a, 15b plurality of current detecting circuits
16 voltage detecting circuit
17 changeover circuit
18, 19 adding circuit
20 signal detecting circuit
21 changeover circuit
24 charging mode detecting circuit
27 timer circuit
29 signal detecting circuit
30 reset circuit
31 AC adaptor side □ display circuit
33 display signal detecting circuit
38 charging capacity arithmetic circuit
39 communication circuit
50, 50A-50J set equipment
E2 secondary cell
51 charging detecting circuit
51i current detecting circuit
51v voltage detecting circuit
51a, 51b plurality of voltage detecting circuits
SW1 protecting switch
51e, 51f voltage detecting circuits before and after switch
51g voltage detecting circuit for performing output control more than cell voltage
52 signal transmitting circuit
53 changeover circuit
54 adding circuit
61 charging completion detecting circuit
62 display signal outputting & changeover circuit
63 display circuit on side of set equipment
64 display signal receiving circuit
SW2 switch circuit for temporary charging stop
72 stopping circuit
SW3 switch circuit for counter flow prevention
74 restarting signal outputting circuit
75 stop resetting circuit
E2A, E2B plurality of secondary cells
51A, 51B plurality of charging detecting circuits
77A, 77B plurality of switch circuits
80 changing signal receiving circuit
81 cell changing mechanical switch
82 microcomputer for charging management

### THE BEST MODE FOR CARRYING OUT THE INVENTION

In the following, the embodiments of the present invention will be described with the attached drawings.

### First Embodiment

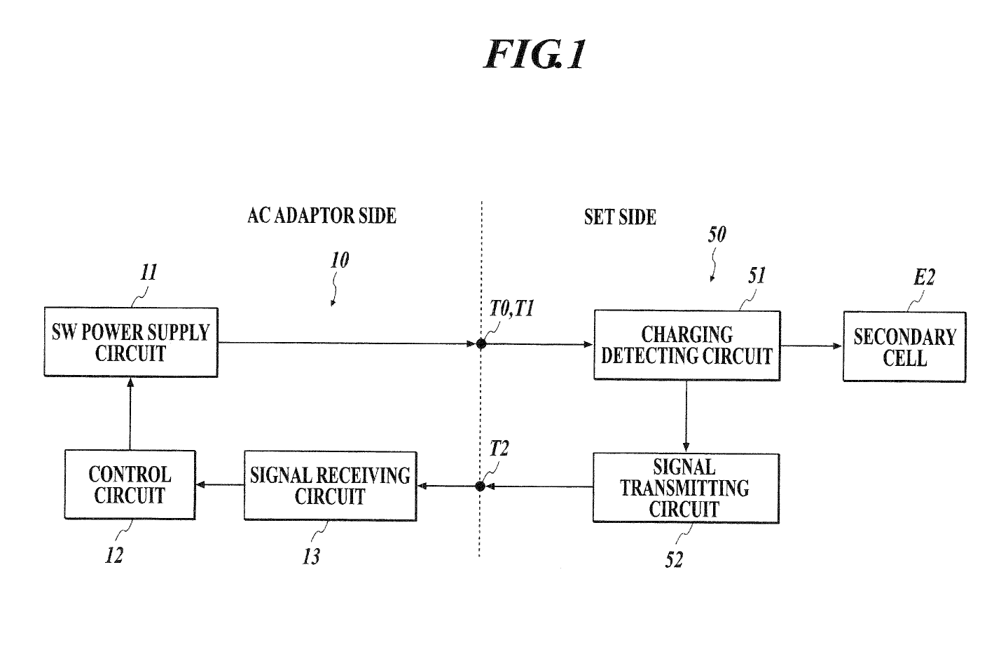

FIG. 1 is a block diagram showing the basic configuration of the charging system of a first embodiment of the present invention.

The charging system of this embodiment includes a piece of set equipment 50 as an electronic circuit device, which is mounted with a secondary cell and operates by the electric power of the secondary cell, and an AC adaptor 10 as a power supply device for charging, which is set to be connectable and removable to the set equipment 50 and performs electric power supply for charging the secondary cell.

Both of the AC adaptor 10 and the set equipment 50 are made to be connectable to each other through a connector with at least three terminals. Two terminals of the three terminals of the connector are power supply terminals TO and T1 for inputting a power supply voltage from the AC adaptor 10 to the set equipment 50, and the other one terminal is a control signal terminal T2 for outputting a signal for a charging control from the set equipment 50 to the AC adaptor 10.

The AC adaptor 10 includes, as shown in FIG. 1, a SW power supply circuit 11 receiving alternating-current power to perform current output controlled by a switching operation of a transistor, a control circuit 12 performing an output control by changing the frequency and on-period of the switching operation of the SW power supply circuit 11, and a signal receiving circuit 13 receiving a signal for a charging control, which signal is transmitted from the set equipment 50.

The set equipment 50 includes a secondary cell E2, a charging detecting circuit 51 detecting a charging current and a charging voltage, a signal transmitting circuit 52, such as a voltage follower, for amplifying a detected signal for transmission, and the like, in addition to a function circuit and the like (not shown) performing a function operation as the set equipment 50.

The secondary cell E2 is configured to be connected to power supply lines from the power supply terminals TO and T1 to receive direct input of a power supply voltage from the AC adaptor 10. No circuits for adjusting the current and the voltage, such as a series regulator and a switching regulator, are provided on the power supply lines between the secondary cell E1 and the power supply terminals TO and T1, and only a switch circuit turning on and off a current input and a resistor for current detection are provided even if some parts are provided.

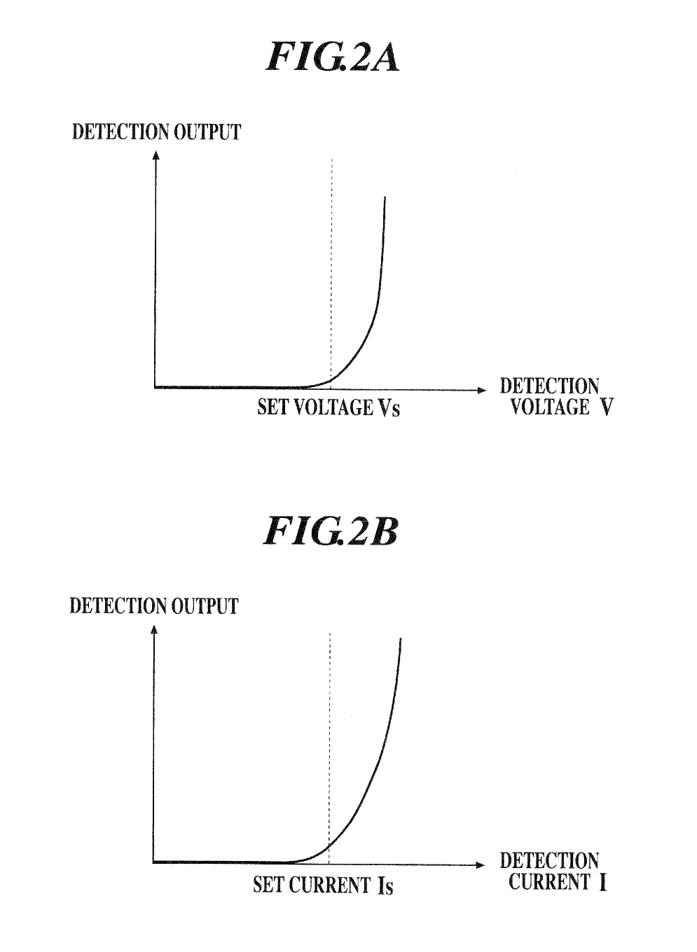

FIGS. 2A and 2B show output characteristic graphs of the charging detecting circuit 51.

The charging detecting circuit 51 includes, for example, a detecting circuit of a charging voltage and a detecting circuit of a charging current. The detecting circuit of the charging voltage between them compares a divided voltage obtained by performing the resistive division of the charging voltage with a reference voltage, and amplifies the obtained voltage difference with an error amplifier. Then the detecting circuit of the charging voltage outputs the detected signal, which is the amplified voltage difference. The error amplifier operates as follow: keeping its output voltage at a reference value (for example, voltage value zero) when the divided voltage is smaller than the reference voltage, and heightening the output voltage when the divided voltage becomes equal to the reference voltage or higher.

Thereby the detected signal output from the detecting circuit of the charging voltage is as follows, as described in FIG. 2A: staying at the reference value (for example, voltage value zero) and not changing until the detection voltage V reaches the neighborhood of a set voltage Vs; raising the voltage value of the detected signal when the charging voltage V reaches the neighborhood of the set voltage Vs; and raising the voltage value of the detected signal by just that much when the charging voltage V exceeds the set voltage Vs.

The set voltage Vs mentioned above can be set at an arbitrary value by selecting the resistance value of the divided resister suitably, and the above-mentioned set voltage Vs is set at the full charge voltage of the secondary cell E2 in this embodiment.

Moreover, the detecting circuit of the charging current similarly outputs a detected signal, which is obtained by comparing a conversion voltage generated between both the ends of a resistor by a charging current with a reference voltage to amplify the voltage difference with an error amplifier. The error amplifier operates as follows: keeping its output voltage at a reference value (for example, voltage value zero) when the conversion voltage is smaller than the reference voltage, and heightening the output voltage when the conversion voltage becomes equal to the reference voltage or higher.

Thereby, the detected signal output from the detecting circuit of the charging current is as follows, as described in FIG. 2B: staying at the reference value (for example, voltage value zero) and not changing until the detection current I reaches the neighborhood of a set current Is; raising the voltage value of the detected signal when the charging current I reaches the neighborhood of the set current Is; and raising the voltage value of the detected signal by just that much when the charging voltage V exceeds the set current Is.

The set current Is mentioned above can be set at an arbitrary value by selecting the resistance value of the resister for current-voltage conversion suitably, and the above-mentioned set current Is is set at the current value according to the capacity of the secondary cell E2 in this embodiment.

Then, the output of the detecting circuit of the charging voltage and the output of the detecting circuit of the charging current are added together, and the added output is configured to be output to the signal transmitting circuit 52. Consequently, as shown in FIGS. 2A and 2B, the detected signal output from the charging detecting circuit 51 is set as follows: staying at the reference value without changing until the charging voltage V or the charging current I reaches the neighborhood of the set voltage Vs or the set current Is, respectively, of each of the detecting circuits; raising the voltage value of the detected signal when either of the charging voltage V and the charging current I reaches the neighborhood of the set voltage Vs or the set current Is, respectively; and raising the voltage value of the detected signal by just that much when either of the charging voltage V and the charging current I exceeds the set voltage Vs or the set current Is, respectively.

When an input detected signal becomes larger than a predetermined voltage, the control circuit 12 of the AC adaptor 10 performs such a control as lengthens the switching frequency of a switching element of the SW power supply circuit 11 or shortens the on-period thereof by the quantity of the surplus to decrease the output current of the SW power supply circuit 11.

Consequently, power supply output according to the secondary cell E2 is performed from the AC adaptor 10 by such a control operation, and charging is performed with a charging voltage and charging current suitable for the secondary cell E2. For example, when the charging rate of the secondary cell E2 is low, charging voltage is low. Consequently, the charging current first reaches a set value, and the output of the charging detecting circuit 51 rises. Thereby the power supply output is suppressed, and the charging current is maintained at a certain value. Hereby the charging of the secondary cell E2 is performed in the constant current mode. Furthermore, when the charging rate becomes higher, the charging voltage becomes higher to reach the set value, and thereby the output of the charging detecting circuit 51 rises. Then, the power supply output is suppressed by the feedback of the detected signal, and the charging voltage is maintained at the certain value. Hereby the charging of the secondary cell E2 is performed in the constant voltage mode.

As described above, according to the charging system of the embodiment, the charging system is configured so that the detection of a voltage and current may be performed on the side of the set equipment 50, and that the output control of the AC adaptor 10 may be performed on the basis of the detected signal configuration. Consequently, the electric power supply according to the set value of the charging detecting circuit 51 is performed from the AC adaptor 10. Thereby, appropriate charging of the secondary cell E2 can be performed without providing any regulator circuits on the side of the set equipment 50. Moreover, it is possible to deal with a plurality of types of set equipment 50 with one type of AC adaptor 10, and it is possible to perform charging by a current value according to each of the different capacities of the secondary cell E2.

Incidentally, although the detection of both of the charging voltage and the charging current is performed on the side of the set equipment 50 and the detected signal is fed back to the side of the AC adaptor 10 in the above-mentioned embodiment, for example, only the detection of the charging voltage may be performed to feed back the detected signal, and the detection of the charging current may be performed on the side of the AC adaptor 10. Moreover, also the signal to be transmitted from the set equipment 50 to the side of the AC adaptor 10 is not limited to the detected signal as mentioned above, but signals of various patterns can be applied as long as the signals can indicate the request of increasing or decreasing the power supply output. Moreover, the present invention can be also applied to such a pattern of performing a charging control as temporarily stops charging with a timer or the like to detect a cell voltage and performs the charging control by using the detected signal.

### Second Embodiment

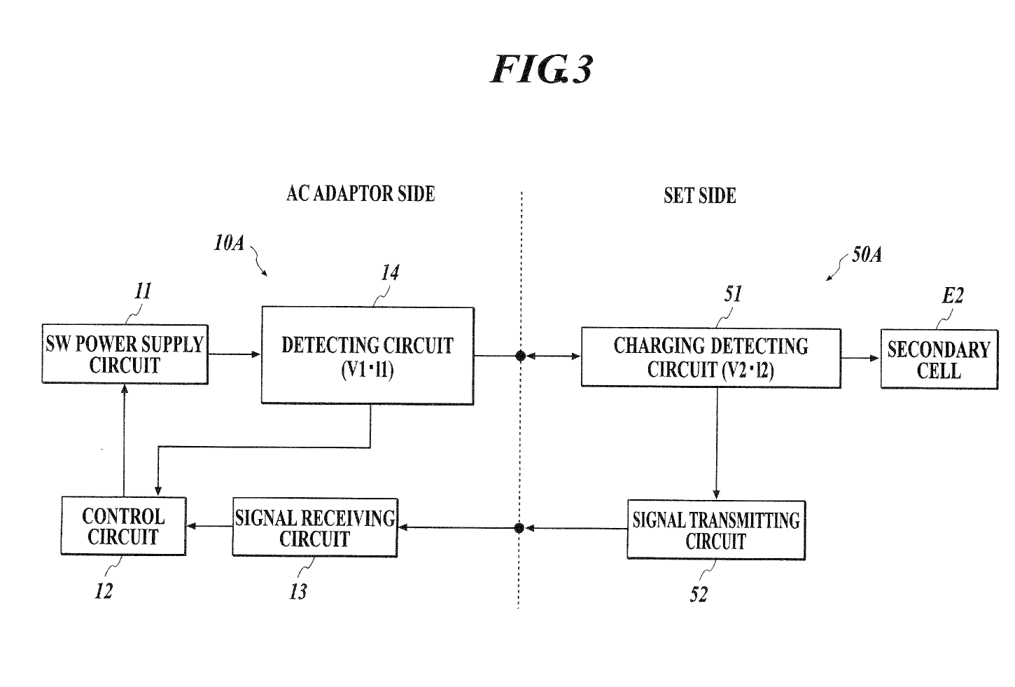

FIG. 3 is a block diagram showing the basic configuration of the charging system of a second embodiment.

The charging system of the second embodiment is provided with a detecting circuit 14 of an output voltage and an output current also on the side of an AC adaptor 10A in addition to the configuration of the first embodiment to enable the control of the SW power supply circuit 11 by using a detected signal on the side of the AC adaptor 10A when the AC adaptor 10A is removed from the set equipment 50.

The detecting circuit 14 keeps an output at a reference value when a detection voltage or a detection current is lower than the set value and raises the output when the detection voltage or the detection current reaches the neighborhood of the set value or when it exceeds the set value similarly to the charging detecting circuit 51.

A set voltage V1 and a set current I1 of the detecting circuit 14 are set to be “I1>I2” and “V1>V2” in comparison with a set voltage V2 and a set current I2 of the charging detecting circuit 51 of the set equipment 50 here.

According to this charging system, the output of the AC adaptor 10A is restricted by the detected signal of the charging detecting circuit 51, and the output voltage and output current of the AC adaptor 10A become lower than the set voltage V1 and set current I1 in the state in which the set equipment 50 and the AC adaptor 10A are connected together. Consequently, the output of the detecting circuit 14 does not rise from the reference voltage and does not exert any influences on the output control in this state.

On the other hand, when the AC adaptor 10A is removed from the set equipment 50, the input of a detected signal from the set equipment 50 disappears, and consequently the output of the AC adaptor 10A increases. Then, the output of the detecting circuit 14 rises to exceed the set voltage V1 or set current I1 of the detecting circuit 14, and the power supply output is suppressed.

Consequently, there can be obtained an advantage that, even when the AC adaptor 10A is removed from the set equipment 50 and the input of a detected signal from the set equipment 50 is cut off, an abnormal rise of the output of the AC adaptor 10A can be prevented.

### Third Embodiment

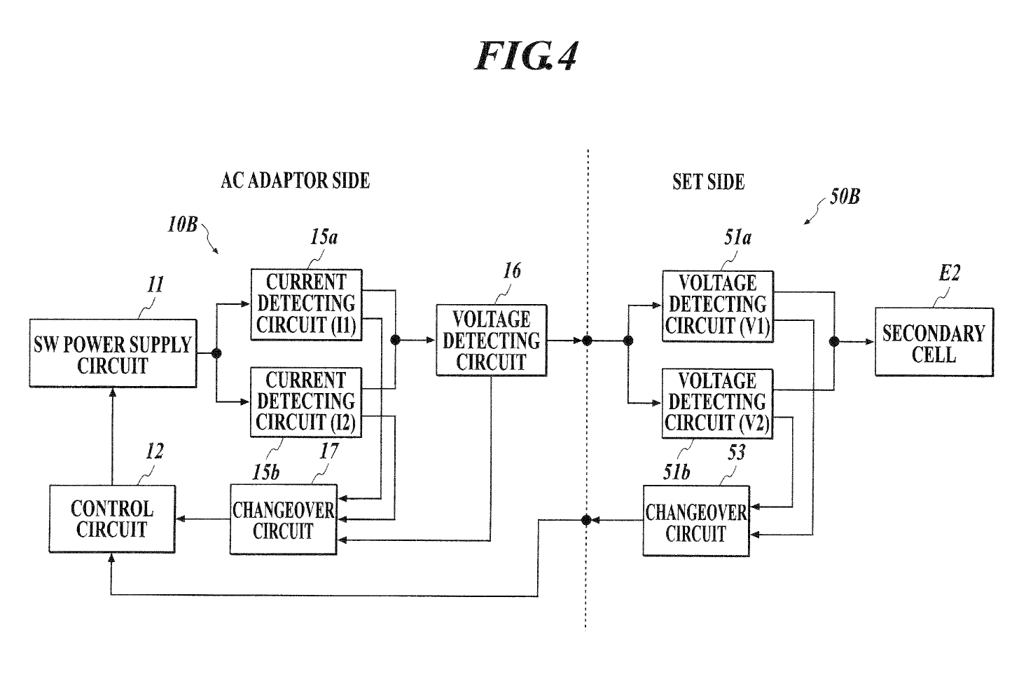

FIG. 4 is a block diagram showing the configuration of the charging system of a third embodiment.

The charging system of the third embodiment is the same as that of the first embodiment in the configuration in which a detected signal for an output control is fed back from a piece of set equipment 50B to an AC adaptor 10B, and the like, but the charging system of the third embodiment differs from that of the first embodiment in that two voltage detecting circuits 51a and 51b are provided as the detecting circuits on the side of the set equipment 50B and two current detecting circuits 15a and 15b are correspondingly provided on the side of the AC adaptor 10B, which two couples of detecting circuits are changed from each other to be used.

The voltage detecting circuits 51a and 51b have set voltages, which are voltage values different from each other, such as “V1=3 V,” and “V2=4.2 V.” Moreover, also the corresponding current detecting circuits 15a and 15b have set currents, which are current values different from each other, such as “I1=1 A” and “I2=0.5 A.”

Moreover, the set equipment 50B is provided with a changeover circuit 53, which selectively changes any one of the detected signals of the two voltage detecting circuits 51a and 51b to output it. The selection of the signal by the changeover circuit 53 is changed on the basis of various conditions by, for example, the microcomputer (not shown) of the set equipment 50B. To put it concretely, the selection of the signal may be also performed as follows: detecting the cell voltage of the secondary cell E2 to change the selection on the basis of the detected value; recognizing the type of the set secondary cell E2 with the microcomputer to change the selection on the basis of the recognition; and changing the selection by an operation input of a user.

On the other hand, AC adaptor 10B is provided with a voltage detecting circuit 16 detecting an output voltage and a changeover circuit 17 selectively changing the outputs of the current detecting circuits 15a and 15b according to the detection voltage to output the changed output to the control circuit 12 in order that the two current detecting circuits 15a and 15b are changed accordingly to the changes of the voltage detecting circuits 51a and 51b of the set equipment 50B.

According to the charging system of this configuration, by the detection of the output voltage by the AC adaptor 10B, the set equipment 50B detects which of the voltage detecting circuits 51a and 51b is selected to operate, and the detected signals of the current detecting circuits 15a and 15b can be changed on the basis of the detection of the set equipment 50B. Thereby, for example, when the voltage detecting circuit 51a of the set voltage of 3 V is selected, the current detecting circuit 15a of the set current of 1 A is selected, and thereby the charging output restricted by the voltage of 3 V and the current of 1 A is preformed. Moreover, when the voltage detecting circuit 51b of the set voltage of 4.2 V is selected, the current detecting circuit 15b of the set current of 0.5 A is selected, and thereby the charging output control restricted by the voltage of 4.2 V and the current of 0.5 A is performed.

By this control, the change on the side of the AC adaptor 10B can be interlocked according to the change on the side of the set equipment 50B. For example, when the cell voltage is rather low, rapid charging is performed, and when the cell voltage becomes high, the charging quantity is changed to a general one. Such a type of charging operation of suppressing the burdens on the secondary cell E2 and the charging circuit can be realized.

Incidentally, although the number of the voltage detecting unit and the current detecting unit are set to two couples, the number may be set to be more. For example, if the voltage detecting unit of a set voltage of 2.5 V and the current detecting unit of a set current of 0.1 C (1 C indicates the current value of discharging the whole capacity of the secondary cell E2 by an hour) are added, then also the output characteristic of performing pre-charging when the cell voltage is very low can be realized.

### Fourth Embodiment

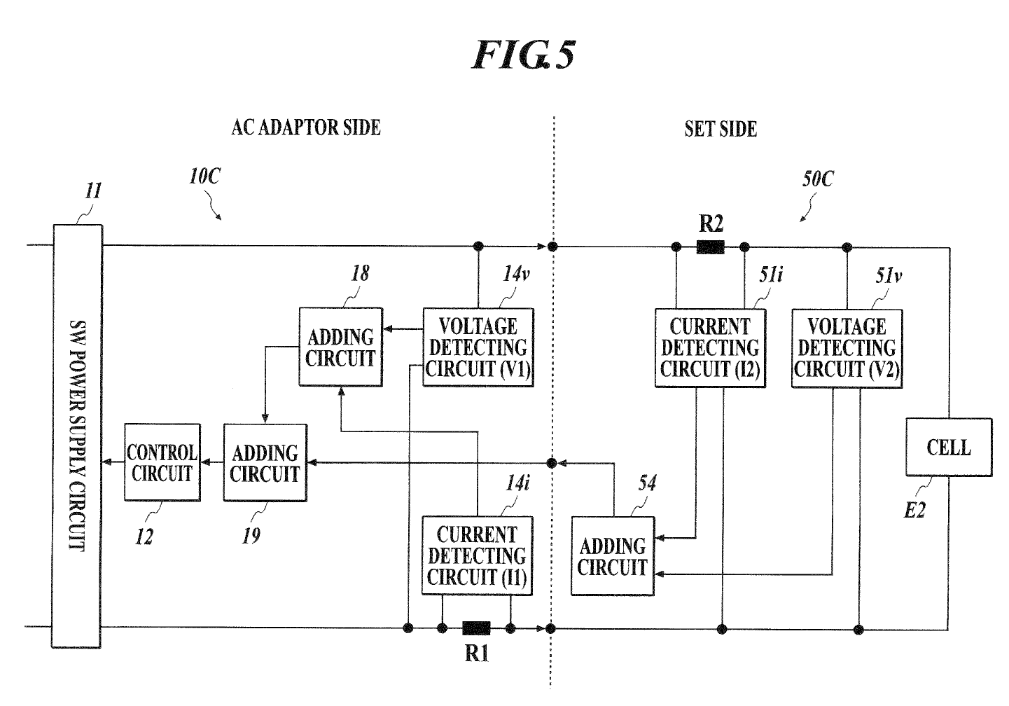

FIG. 5 is a block diagram showing the configuration of the charging system of a fourth embodiment.

The charging system of the fourth embodiment is the one implemented by being concretely configured so that a detected signal transmitted from the side of a piece of set equipment 50C and a detected signal detected on the side of an AC adaptor 10C may be input into the control circuit 12 in the configuration almost similar to that of the charging system of the second embodiment.

A voltage detecting circuit 51v and a current detecting circuit 51i on the side of the set equipment 50C displace detected signals from reference values when their detected values reach the neighborhood of a set voltage and a set current, respectively, or exceed the set voltage and the set current. Consequently, as described in the description of the second embodiment, these detected signals are added to each other by an adding circuit 54 to be output to the side of the AC adaptor 10C, and thereby the output control based of the detection of both of the detected signals can be performed.

Similarly, because a voltage detecting circuit 14v and a current detecting circuit 14i on the side of the AC adaptor 10C are similarly configured, these detected signals are added to each other by an adding circuit 18 to be output to the control circuit 12, and thereby the output control based on the detection of these detected signals can be performed.

Moreover, the additional signal of the detected signals from the set equipment 50C and the addition signal of the AC adaptor 10C are further added to each other in an adding circuit 19 to be output to the control circuit 12, and thereby when any one of the outputs of the respective detecting circuits 14v, 14i, 51v, and 51i is displaced from the reference value earlier, the output control based on the displaced output is performed. Therefore, by suitably selecting the set voltages and set currents of these detecting circuits 14v, 14i, 51v, and 51i in advance, the output control can be set be to be performed as follows: if the set equipment 50C and the AC adaptor 10C are connected with each other, then the output control based on the detecting circuits 51v and 51i on the side of the set equipment 50C is performed; and if the set equipment 50C is taken off, then the output control based on the detecting circuits 14v and 14i on the side of the AC adaptor 10C is performed.

That is, by setting as follows in advance: set voltage V1 (detecting circuit 14v)>set voltage V2 (detecting circuit 51v), and set current I1 (detecting circuit 14i)>set current I2 (detecting circuit 51i), the output control as mentioned above can be realized. The output put control is the same as that described with regard to the second embodiment.

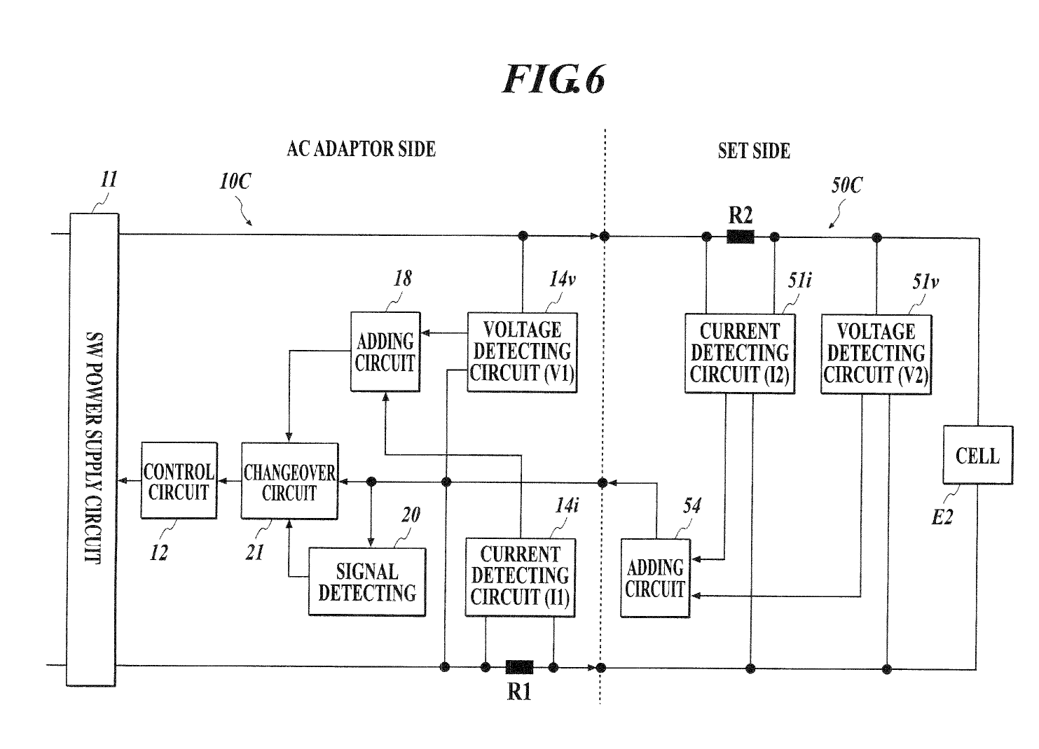

FIG. 6 shows a block diagram of another configuration example for outputting a detected signal to the control circuit 12.

Moreover, in order to perform a control on the basis of either of the detected signal from the set equipment 50C and the detected signal obtained on the side of the AC adaptor 10C, the following configuration as shown in FIG. 6 may be used in addition to the above-mentioned configuration based on the set voltage and the set current: a signal detecting circuit 20 detects the existence of a detected signal from the set equipment 50C; and a changeover circuit 21 outputs the detected signal of the set equipment 50C to the control circuit 12 if the detected signal exists, or outputs the detected signal on the side of the AC adaptor 10C to the control circuit 12 if the detected signal of the set equipment 50C does not exists.

According to this configuration, although the circuit configuration thereof is slightly complicated, the values of the set current and set voltage of detecting circuits 14v and 14i are not restricted, and consequently for example it becomes possible to reduce the output of the AC adaptor 10 when the set equipment 50C is not connected and to set the set voltage at the voltage at which the standby power becomes minimum by reducing the values of the set voltage V1 and the set current I1.

### Fifth Embodiment

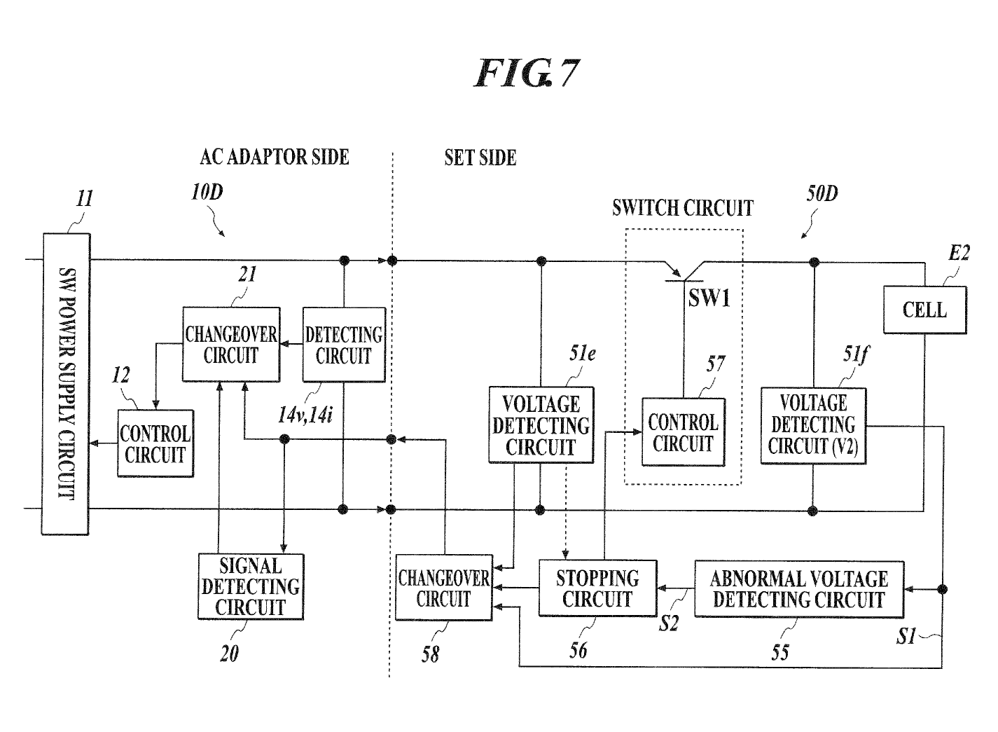

FIG. 7 is a block diagram showing the configuration of the charging system of a fifth embodiment.

The charging system of the fifth embodiment includes an AC adaptor 10D similar one to the aforesaid configuration of FIG. 6, and a piece of set equipment 50D different in configuration from that of FIG. 6.

The set equipment 50D of this embodiment is provided with a protecting switch SW1 for breaking the power supply input to the secondary cell E2 when the voltage at the time of charging exceeds a restricted voltage owing to some abnormality. Furthermore, voltage detecting circuits 51e and 51f are provided on both the end sides of the protecting switch SW1, and their outputs are selectively changed to be output to the AC adaptor 10D.

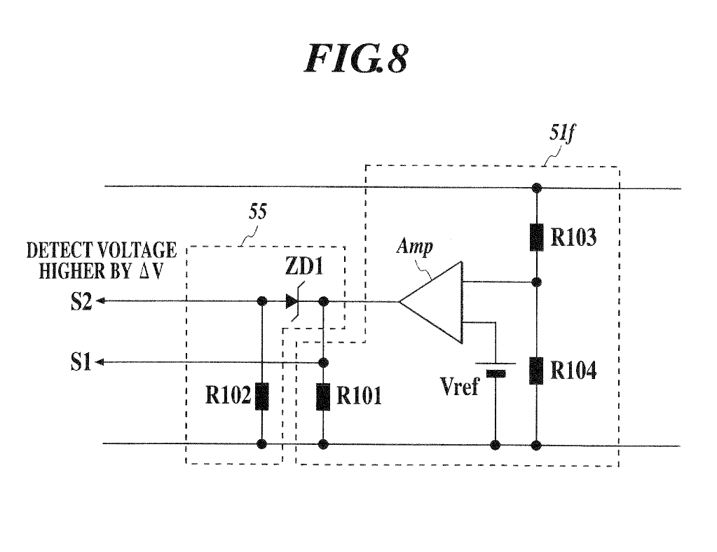

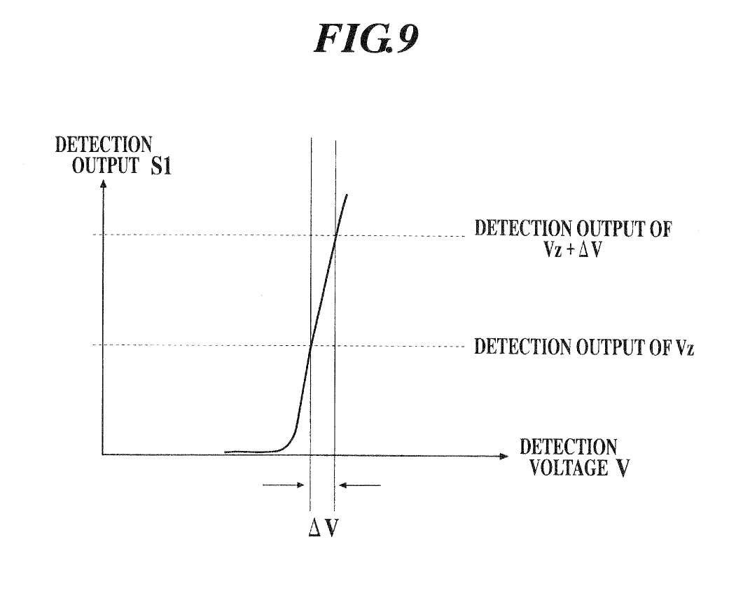

FIG. 8 shows examples of the concrete circuits of the voltage detecting circuit 51f and an abnormal voltage detecting circuit 55, and FIG. 9 shows a characteristic graph illustrating a detection operation of the abnormal voltage detecting circuit 55.

As shown in FIG. 9, the protecting switch SW1 performs off-operation, for example, when the input voltage into the secondary cell E2 becomes the voltage higher than a set voltage Vz by ΔV or more. In detail, the abnormal voltage detecting circuit 55 detects that the input voltage becomes the voltage higher than ΔV or more from a detected signal S1 of the voltage detecting circuit 51f; a stopping circuit 56 outputs an operation stopping signal on the basis of a detection output S2; and a control circuit 57 performs the off-operation of the protecting switch SW1.

The abnormal voltage detecting circuit 55 can be configured, for example, as shown in FIG. 8, to detect the output of the voltage detecting circuit 51f when the output exceeds the Zener voltage of a Zener diode ZD1, and to distinguish the output as the above-mentioned abnormal value.

In this embodiment, a changeover circuit 58 is configured to select an output of the voltage detecting circuit 51f on the side of the secondary cell E2 when the protecting switch SW1 is on, and to select an output of the voltage detecting circuit 51e on the input terminal side when the protecting switch SW1 is off on the basis of a signal from the stopping circuit 56, and further to output the selected output to the AC adaptor 10D.

By the change of this detected signal, the voltage immediately before the secondary cell E2 is detected at the time of charging, and thereby an accurate charging control can be performed. If the protecting switch SW1 operates to break charging, the voltage to be input into the secondary cell E2 is changed to a detected signal by the voltage detecting circuit 51e before the protecting switch SW1. Consequently, a defect in which the output voltage of the AC adaptor 10D abnormally rises without any detected signals can be avoided.

Incidentally, the on-off control of the protecting switch SW1 is not restricted to the above-mentioned example, but for example, as shown by a dotted line in FIG. 7, the voltage detecting circuit 51e may be configured so that, if an overvoltage is applied from the side of the AC adaptor 10D, then the voltage detecting circuit 51e detects the overvoltage to operate the stopping circuit 56.

### Sixth Embodiment

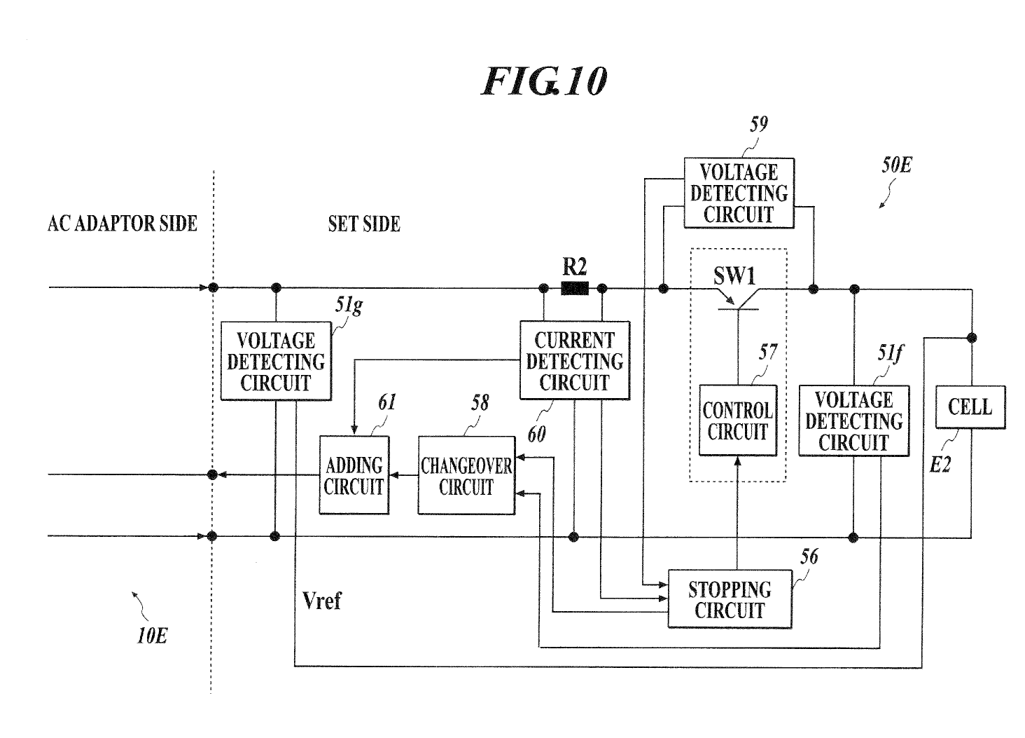

FIG. 10 is a block diagram showing the configuration of the charging system of a sixth embodiment.

The charging system of the sixth embodiment is configured as follows: the protecting switch SW1 is connected in series on the power supply line; the voltage detecting circuits are provided on both the end sides of the switch SW1; and the detected signals of the voltage detecting circuits are selectively changed to be output into an AC adaptor 10E, similarly to the fifth embodiment. Furthermore, the embodiment is configured to control the output voltage of the AC adaptor 10E to a voltage larger than the cell voltage of the secondary cell E2 by a little lest a current should perform counter flow from the secondary cell E2 when the protecting switch SW1 operates to be off.

This embodiment is configured so that the protecting switch SW1 is turned off to break the power supply input to the secondary cell E2 when an input voltage or an input current exceeds their rated values owing to some abnormality, or when the secondary cell E2 becomes its full charge. For example, the embodiment is configured so that a voltage detecting circuit 59 detects the voltage between both the terminals of the protecting switch SW1 to detect an overcurrent input and an overvoltage input, or so that, if a charging current reduces and a current detecting circuit 60 detects the full charge, the stopping circuit 56 performs a stopping operation on the basis of these pieces of detections.

Furthermore, the embodiment is configured to obtain a reference voltage Vref to be compared with a detection voltage from the cell voltage of the secondary cell E2 in a voltage detecting circuit 51g at the preceding stage of the protecting switch SW1. Thereby, when the detection voltage exceeds the cell voltage of the secondary cell E2 by the predetermined quantity, the detected signal rises.

The change of the detected signal by the changeover circuit 58 is performed similarly to the fifth embodiment so that the detected signal on the side of the secondary cell E2 may be selected when the protecting switch SW1 is on, and so that the detected signal on the side of the input terminal when the protecting switch SW1 operates to be off.

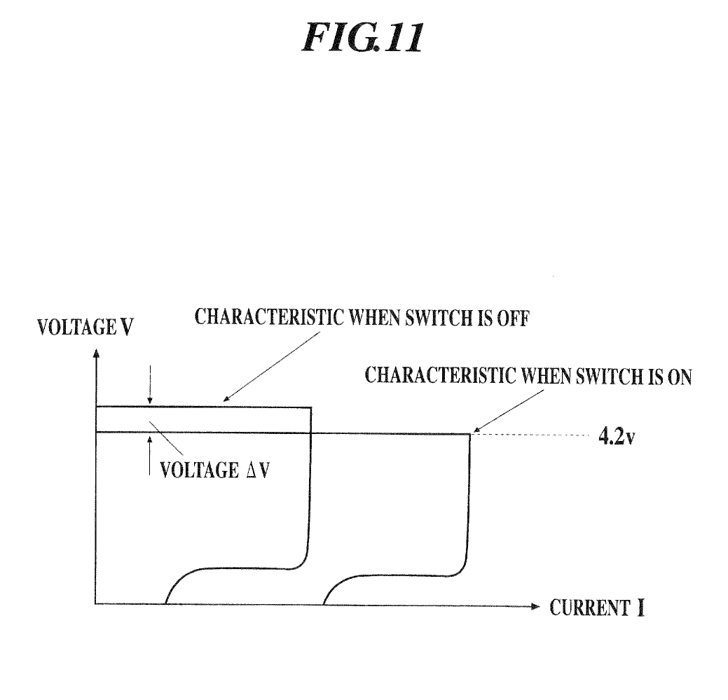

FIG. 11 shows an output characteristic graph of the AC adaptor 10E in the charging system.

According to the configuration mentioned above, when the protecting switch SW1 operates to be off, an output of the voltage detecting circuit 51g based on the cell voltage of the secondary cell E2 as the reference voltage Vref is output to the side of the AC adaptor 10E, and consequently the input voltage from the AC adaptor 10E becomes a voltage higher than the cell voltage by the ΔV to enable the prevention of the counter flow of the current from the secondary cell E2 to the side of the AC adaptor 10E through a some current path. When the secondary cell E2 is full charge and the protecting switch SW1 operates, as shown in FIG. 11, the input voltage becomes a voltage higher than the full charge voltage by a little, and the counter flow of a current can be prevented. In addition, as shown in FIG. 11, the restricted value of the output current may be controlled to be reduced when the protecting switch SW1 operates.

### Seventh Embodiment

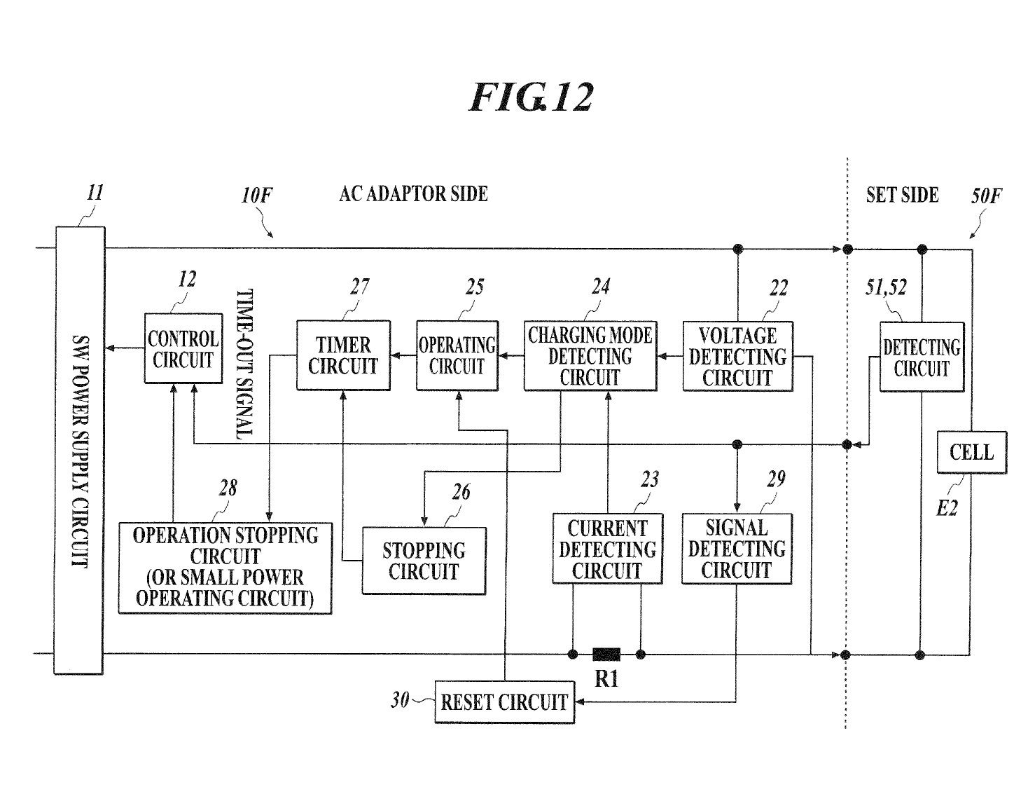

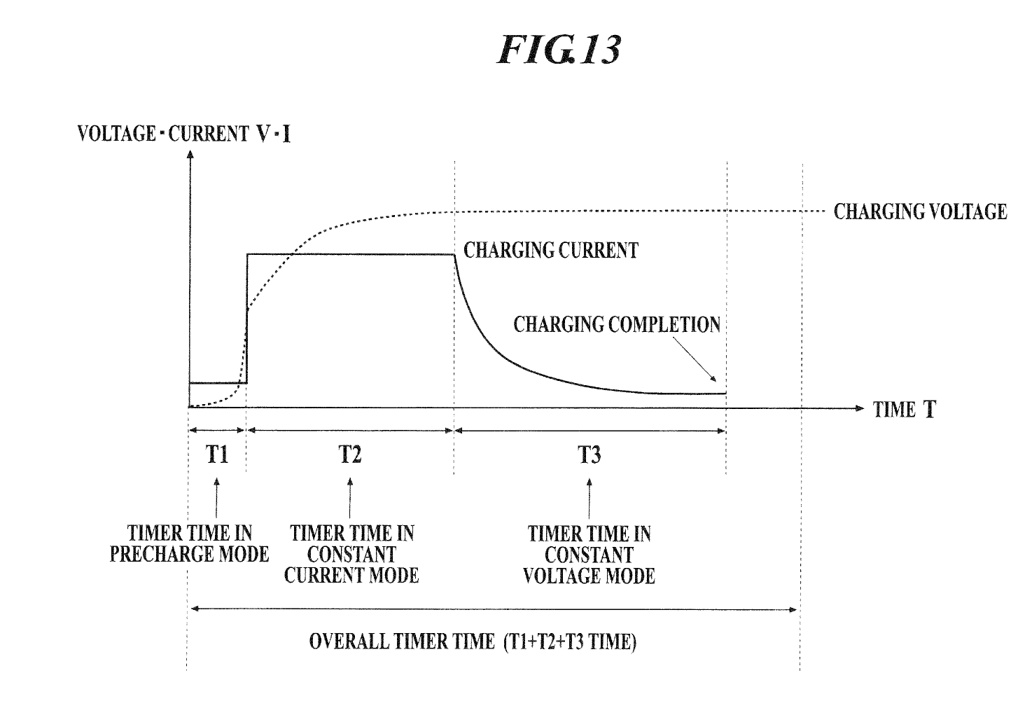

FIG. 12 is a block diagram showing the configuration of the charging system of a seventh embodiment, and FIG. 13 is a diagram showing a charging characteristic of a secondary cell.

The charging system of the seventh embodiment has the same configuration as those of the embodiments described above in that a piece of set equipment 50F transmits a detected signal to the side of an AC adaptor 10F to perform the output control of the control circuit 12 of the AC adaptor 10F on the basis of the detected signal. The seventh embodiment adds a time function on the side of the AC adaptor 10F in order to prevent any overcharge in addition to the above configuration.

The AC adaptor 10F includes three charging modes to the secondary cell E2, such as a lithium ion cell, as a charging object: a precharge mode (see FIG. 13) for performing charging with a small charging current when a cell voltage is very low, a constant current mode for performing charging with a general charging current, and a constant voltage mode for performing charging at a constant voltage from the time when the cell voltage becomes the full charge voltage to a time when the charging current becomes small. The AC adaptor 10F times the pieces of elapsed time T1, T2, and T3 of the charging modes to monitor whether the same charging mode is continuing over a predetermined time or not. If the AC adaptor 10F judges that the same charging mode is continuing over the predetermined time, then the AC adaptor 10F stops the output of electric power, or changes to small power output.

Accordingly, the AC adaptor 10F is provided with a voltage detecting circuit 22 detecting an output voltage, a current detecting circuit 23 detecting an output current, and a charging mode detecting circuit 24 distinguishing a charging mode on the basis of the detected values in order to detect the present charging mode. It is known that the charging characteristic of a lithium ion cell changes in current and voltage as shown in FIG. 13, and the charging mode detecting circuit 24 can identify in which charging mode the AC adaptor 10F operates by comparing the magnitude and variation of the output voltage and the magnitude and variation of the output current with the variation of a standard charging characteristic line.

Moreover, the AC adaptor 10F is provided with a timer circuit 27, and an operating circuit 25 and stopping circuit 26 for starting the timing of the timer circuit 27 and stopping the timing thereof to reset the timing circuit 27 in order to perform the above-mentioned timing.

The timer circuit 27 is configured to perform the timing of the elapsed time of each charging mode, and to output a time-out signal at the time of elapsing the predetermined time defined to each charging mode in advance. The operating circuit 25 outputs a signal indicating in which charging mode timing is started to the timer circuit 27, and the stopping circuit 26 stops the timing of the timer circuit 27 and resets the timing at the time of a change of the charging mode.

Then, when a time-out signal is input from the timer circuit 27 into an operation stopping circuit 28, a control signal for making the control circuit 12 stop output until an AC power supply is pulled out to reset the AC adaptor 10F, and the output of the AC adaptor 10F is stopped. Alternatively, a small power operating circuit may be provided in place of the operation stopping circuit 28 to make the control circuit 12 perform an output control of little electric power by the control signal from the small power operating circuit.

Moreover, the AC adaptor 10F is configured to detect that the AC adaptor 10F is connected to the set equipment 50F, and that the AC adaptor 10F is taken off from the connection by a signal detecting circuit 29, and to initialize the operation of the timer circuit 27 with a reset circuit 30 when the connection or the taking off from the connection is detected.

According to this configuration, the AC adaptor 10F is configured so as to time the operation time of each charging mode during the charging of the secondary cell E2, and so as to detect the lasting of the same charging mode for a long time owing to being unable to performing normal charging due to, for example, the deterioration of the secondary cell E2 with the timer circuit 27, and further so as to stop the output of the AC adaptor 10F or so as to change the output of the AC adaptor 10F of little electric power.

Incidentally, although the aforesaid embodiment monitors the timing and overtime of each charging mode, the monitoring may be performed to the timing and overtime of total charging time totalizing the time of each charging mode, or both of the monitoring methods may be performed.

### Eighth Embodiment

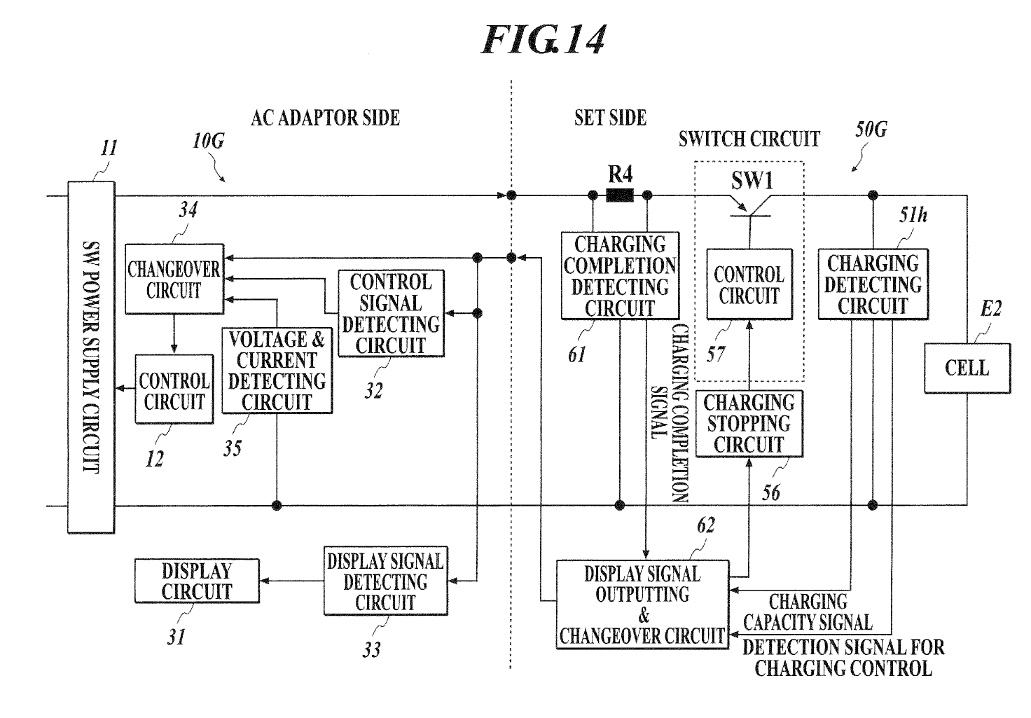

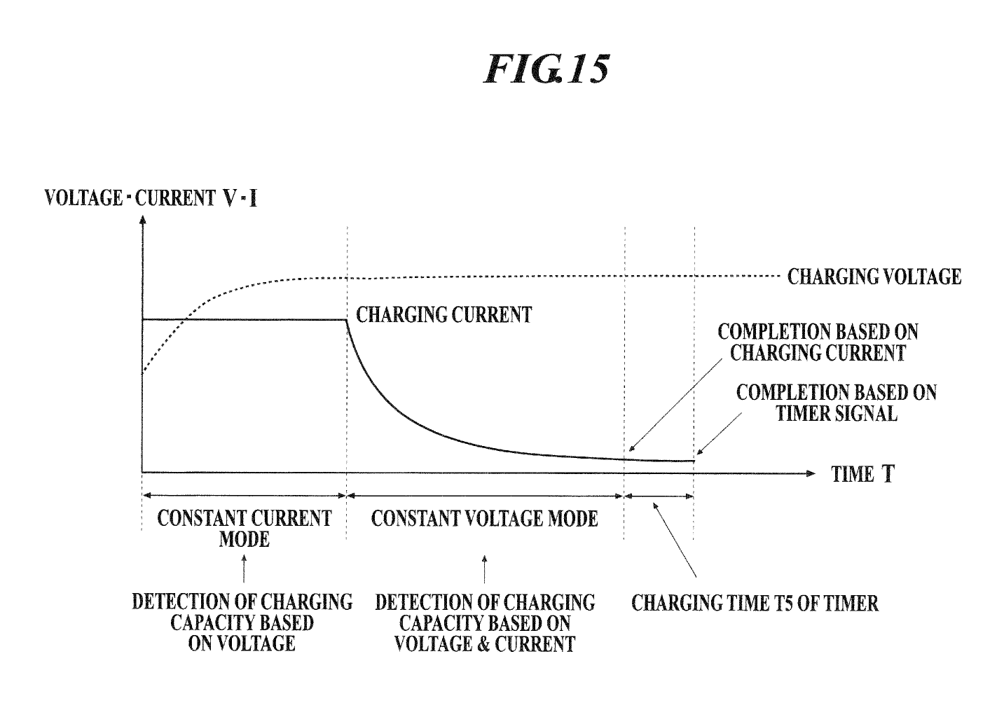

FIG. 14 is a block diagram showing the configuration of the charging system of an eighth embodiment, and FIG. 15 is a graph showing a charging characteristic of the secondary cell E2 by the charging system.

The charging system of the eighth embodiment adds the function of displaying the state of being in charging or being in the completion of charging with a display circuit 31 using, for example, a light emitting diode (LED) or a simple display panel in a connection portion of an AC adaptor 10G or a charging stand for performing charging by placing a piece of set equipment 50G thereon.

Moreover, the charging system of the eighth embodiment is configured so that the state of being charging or being the completion of charging is detected by the set equipment 50G, and that a display signal corresponding to the state is transmitted from the set equipment 50G to the side of the AC adaptor 10G by diverting the signal line of the detected signal for a charging control.

The set equipment 50G is provided with a charging detecting circuit 51h detecting a voltage or a current for a charging control to output the detected signal for a charging control, the protecting switch SW1 breaking the power supply input into the secondary cell E2 at the time of transmission of a display signal, the charging stopping circuit 56 and the control circuit 57 both operating the protecting switch SW1, a charging completion detecting circuit 61 detecting the full charge from the charging current, a display signal outputting & changeover circuit 62 outputting a display signal indicating a charged state and a detected signal for a charging control, and the like.

The charging detecting circuit 51h detects a charged quantity of the secondary cell on the basis of the charging voltage and the charging current in addition to the detected signal for a charging control to output a charged quantity detected signal indicating the detected charging voltage and charging current to the display signal outputting & changeover circuit 62.

When the charging current becomes less than the predetermined value, the charging completion detecting circuit 61 judges that the secondary cell E2 is in full charge, and outputs a signal indicating the charging completion to the display signal outputting & changeover circuit 62. This is to detect the full charge by using the fact that it is determined to be in full charge in charging of a lithium ion cell or the like when a current value becomes small in the charging of the constant voltage mode as shown in FIG. 15. Moreover, the method may be also used that the charging completion detecting circuit 61 is mounted with a timer and charging is continued for a predetermined time T5 from the time when a charging current becomes less than a predetermined value to judge charging completion on the basis of a timer signal after the elapse of a predetermined time. This method can make a charged quantity a little more.

The display signal outputting & changeover circuit 62 outputs a detected signal for a charging control from the charging detecting circuit 51h to the side of the AC adaptor 10G at a normal time. On the other hand, in the case where the charged state of the secondary cell E2 changes, such as the case where a charging completion signal is input and the case where a charging capacity signal exceeds a predetermined threshold value, the display signal outputting & changeover circuit 62 is configured to output a display signal according to the charged state to the AC adaptor 10G. The display signal is configured to be capable of being distinguished from the detected signal for a charging control by, for example, being made to be a signal modulated by a predetermined frequency, or being made to be a digital signal.

Moreover, the AC adaptor 10G is provided with a control signal detecting circuit 32 detecting whether a detected signal for a control is input from the control signal line or not, a display signal detecting circuit 33 detecting and demodulating a display signal to output the demodulated display signal to the display circuit 31 when the display signal is input through the control signal line, a voltage & current detecting circuit 35 for generating a dummy detected signal when the detected signal of the set equipment 50G stops, a changeover circuit 34 outputting the signal on the control signal line to the control circuit 12 when the detected signal for a control is input therein and outputs the above-mentioned dummy detected signal to the control circuit 12 when the detected signal is not input therein, and the like.

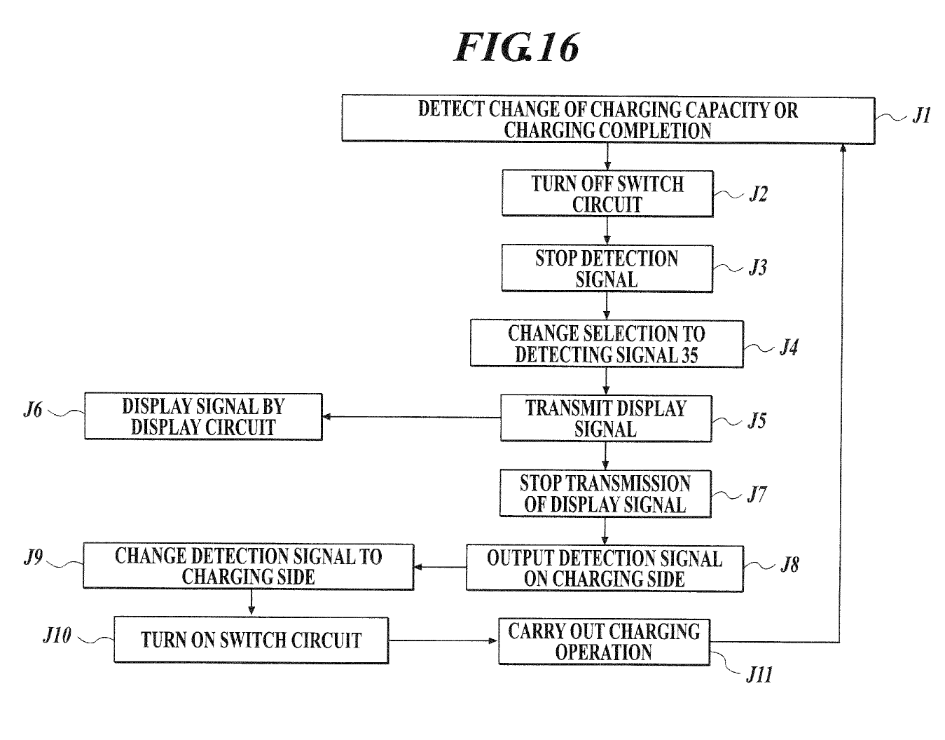

FIG. 16 shows a flow chart illustrating an example of the operation of the charging system.

According to the charging system configured as mentioned above, if the charging capacity signal indicates that the charging rate exceeds, for example, 30%, 60%, and 90%, or if it is detected that a charging completion signal is asserted (Step J1), then the display signal outputting & changeover circuit 62 operates to turn off the protecting switch SW1 (Step J2), and stops the output of the detected signal for a charging control to the side of the AC adaptor 10G (Step J3).

On the side of the AC adaptor 10G, the stop of the input of the detected signal is detected by the control signal detecting circuit 32, which changes the selection of the changeover circuit 34 to the signal of the detecting circuit 35 (Step J4). Thereby, the output of the AC adaptor 10G is controlled to the predetermined voltage, and it can be avoided that the output of the AC adaptor 10G abnormally rises without any detected signals.

Moreover, at the same time, a display signal according to the change of the charged state is transmitted from the display signal outputting & changeover circuit 62 (Step J5), and the display signal is received by the display signal detecting circuit 33, and the display form of the display circuit 31 is changed (Step J6). For example, a display color and a blinking speed are changed. Moreover, it is also possible to perform a character display on a display panel.

Next, the transmission of the display signal of the display signal outputting & changeover circuit 62 is stopped (Step J7), and the signal output to the side of the AC adaptor 10G is changed to the detected signal from the charging detecting circuit 51h (Step J8). Then, the control signal detecting circuit 32 detects the change and changes the selection of the changeover circuit 34 to the detected signal input from the set equipment 50G (Step J9). At the same time, the protecting switch SW1 of the set equipment 50G is turned on (Step J10), and the charging operation is continued until the next change of the charged state (Step J11).

As described above, according to the charging system of this embodiment, the output control of the AC adaptor 10G can be performed by the voltage and current detection on the side of the set equipment 50G, and the control signal line is diverted to output the display signal indicating the charged sate from the set equipment 50G. Thereby, the advantage of enabling the display output of the charged state on the side of the AC adaptor 10G can be obtained.

### Ninth Embodiment

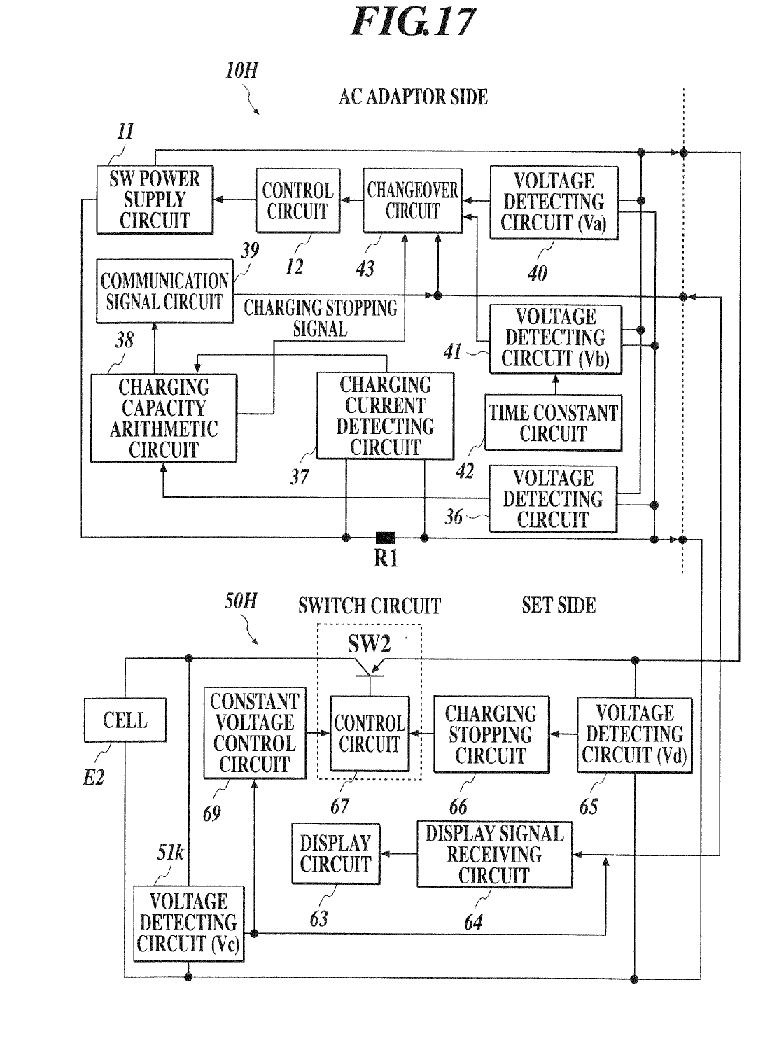

FIG. 17 is a block diagram showing the configuration of the charging system of a ninth embodiment.

The charging system of the ninth embodiment is configured so that an AC adaptor 10H performs the detection of a charged state and the generation of a display signal according to the charged state to output the generated display signal, and that a piece of set equipment 50H performs the display output based on the display signal in the case where, for example, the set equipment 50H is very small in size, or the set equipment 50H cannot be mounted with any large scale integrated circuits (LSI) and the like to be unable to perform any distinction processing on the side of the set equipment 50H.

Accordingly, the AC adaptor 10H of this embodiment is provided with a voltage detecting circuit 36, a current detecting circuit 37, and an arithmetic circuit 38 calculating the charging capacity of the secondary cell E2 on the basis of the detected values in order to calculate the charged state of the secondary cell E2 on the basis of the output voltage and the output current. Moreover, the AC adaptor 10H is provided with a communication circuit 39 outputting the display signal onto the control signal line at the time of a change of the charged state, a changeover circuit 43 performing a change of a detected signal in order to stop the charging operation on the side of the set equipment 50H at the time of outputting the display signal, voltage detecting circuits 40 and 41 generating a dummy detected signal in order to stop or restart the charging operation on the side of the set equipment 50H, and a time constant circuit 42 for stopping the operation of the one side voltage detecting circuit 41 for a predetermined remarkably short time.

Moreover, the set equipment 50H is provided with a display circuit 63, such as an LED, a receiving circuit 64 receiving the display signal through the control signal line, a switch circuit SW2 stopping the charging operation at the time of the input of the display signal, a voltage detecting circuit 65 detecting the arrival of the receiving timing of the display signal on the basis of an input voltage, a charging stopping circuit 66 turning off the switch circuit SW2 during a reception period of the display signal, a control circuit 67 driving the switch circuit SW2, and a constant voltage control circuit 69 making the switch circuit SW2 temporarily perform a regulator operation in addition to the secondary cell E2 and a voltage detecting circuit 51k detecting a charging voltage to output the detected signal to the AC adaptor 10H.

The above-mentioned configuration is made to be as follows: set voltages Va-Vd are set in the two voltage detecting circuits 40 and 41 of the AC adaptor 10H and the two voltage detecting circuits 51k and 65 of the set equipment 50H, respectively; if a detection voltage is less than each of the set voltages Va-Vd, then a detected output is maintained to the reference value (for example, voltage value zero); and if the detection voltage is more than the set voltage, then the detected output is raised.

Moreover, each of the set voltages are set as follows: Va>Vd, Vd>Vc, and Vd>Vb, wherein the set voltage Vc is set at the full charge voltage of the secondary cell E2.

According to this configuration, the following charging operation and the transmission and reception processing of the display signal are performed.

That is, at the ordinary charging time, an additional signal of the detected outputs of the voltage detecting circuit 51k (set voltage Vc) of the set equipment 50H and a not shown current detecting circuit is input into the control circuit 12, and the output control of the AC adaptor 10H and the constant current and constant voltage charging of the secondary cell E2 are performed. Since the set voltage Vd of the voltage detecting circuit 65 is larger than the set voltage Vc, the output of the voltage detecting circuit 65 (set voltage Vd) is kept to be negated during this time.

If charging has advanced and then the charging rate of the secondary cell E2 exceeds a certain value or if the charging is completed, those states are calculated by the arithmetic circuit 38 of the AC adaptor 10H, and an output command of a display signal is transmitted to the communication circuit 39. Then, the selection of the changeover circuit 43 is changed from the detected signal (set voltage Vc) on the side of the set equipment 50H to the detected signal of the voltage detecting circuit 40 (set voltage Va).

Then, since the set voltage becomes the high voltage Va by the change of the detected signal, the output voltage of the AC adaptor 10H rises. Furthermore, by the rise, the detected signal of the voltage detecting circuit (set voltage Vd) of the set equipment 50H is asserted, and the fact that the time is a reception period of a display signal is transmitted. Then, by the assertion signal, the switch circuit SW2 is turned off, and charging is stopped. When the charging is stopped, the output of the voltage detecting circuit 51k (set voltage Vc) is also not performed, and the voltage of the control signal line falls to the reference voltage.

Then, a display signal is transmitted from the communication circuit 39 of the AC adaptor 10H to the receiving circuit 64 of the set equipment 50H during the charge stopping period, and the display mode of the display circuit 63 is changed according to the charged state on the basis of the display signal.

Next, by the falling of the voltage of the control signal line to the reference voltage, the changeover circuit 43 changes the selection of the detected signal to the output of the voltage detecting circuit 41 (set voltage Vb). Thereupon, since the set voltage Vb is set to be low, the output voltage of the AC adaptor 10H falls, and the output of the voltage detecting circuit 65 (set voltage Vd) is negated. Then, hereby, the end of the communication period of the display signal is transmitted.

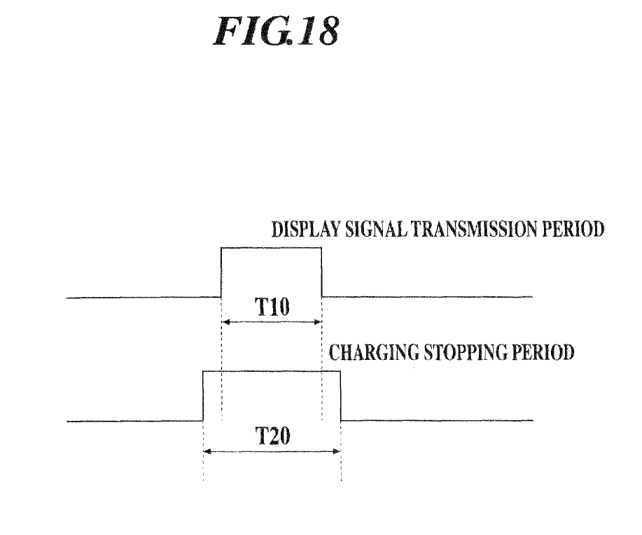

The timing designing of a charging stopping time T20 and a transmission and reception time T10 of the display signal is performed so that “T10<T20” as shown in FIG. 18 here.

Furthermore, by the above-mentioned negated signal, the switch circuit SW2 is turned on, and the power supply input to the secondary cell E2 is restarted. Thereby, the detected signal for an output control is output from the set equipment 50H to the side of the AC adaptor 10H. Moreover, the operation of the voltage detecting circuit 41 of the low set voltage Vb is stopped only for a short time by the time constant circuit 42, and the detected signal from the side of the set equipment 50H is used for the control of the control circuit 12, and the secondary cell E2 is again returned to its ordinary charged state.

Incidentally, by making the switch circuit SW2 perform the regulator operation by working the constant voltage control circuit 69 when a high voltage is input into the set equipment 50H, charging can be continued even in that period.

As described above, according to the charging system of this embodiment, a display signal can be transmitted from the AC adaptor 10H to the set equipment 50H by the control signal line, even in a system in which an LSI, such as a microcomputer, is mounted on the side of the AC adaptor 10H and not so many circuits are mounted on the set equipment 50H, display output according to a charged state can be performed on the side of the set equipment 50H.

Incidentally, the electronic circuit device including the secondary cell E2 is expressed as the set equipment 50H in the above-mentioned description. If the electronic circuit device is, for example, a cell pack made by packaging the secondary cell E2 and a circuit for a charging control together, the present embodiment is especially useful because no LSIs or the like can be mounted on the cell pack.

### Tenth Embodiment

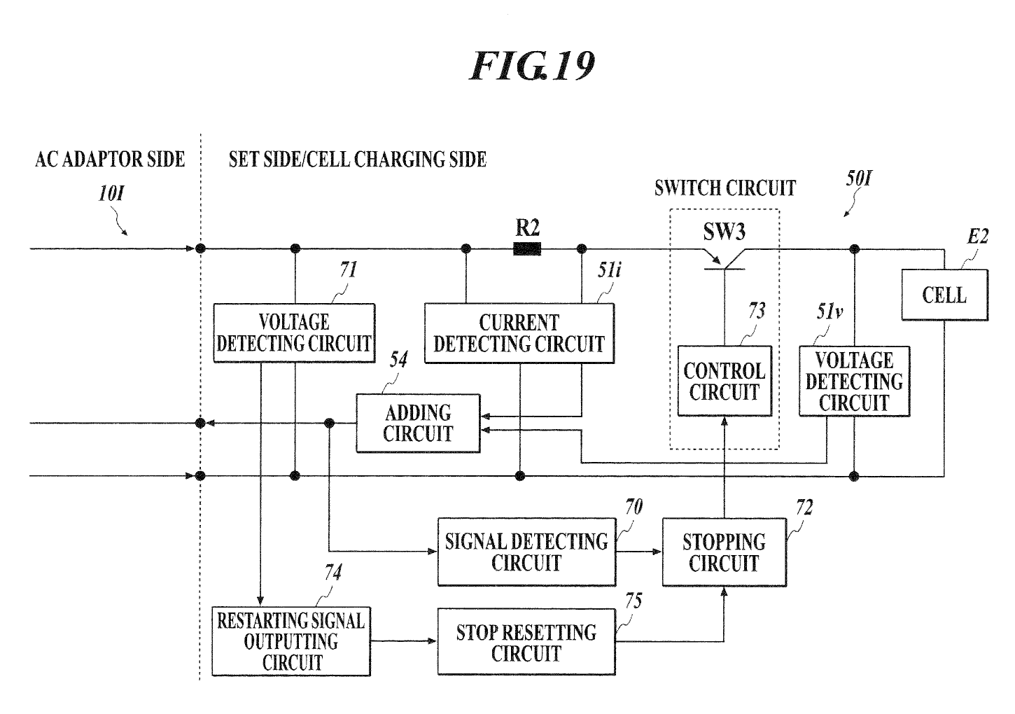

FIG. 19 is a block diagram showing the configuration of the charging system of a tenth embodiment.

The charging system of the tenth embodiment is configured so that no counter flows of currents may be caused from a piece of set equipment 50I to the side of an AC adaptor 10I, for example, in the case where the plug for power supply of the AC adaptor 10I is pulled out from a plug receptacle while the AC adaptor 10I is left to be connected to the set equipment 50I.

The set equipment 50I of this embodiment is provided with a switch circuit SW3 connected between the input terminal and the secondary cell E2 in series in order to prevent the counter flow current, a signal detecting circuit 70 for detecting the state having the possibility of the counter flow, a voltage detecting circuit 71 for detecting a restarting state in which the off-state of a switch is released, a stopping circuit 72 for performing on-off control of the switch circuit SW3, a control circuit 73, a restarting signal outputting circuit 74, and a stop resetting circuit 75 in addition to the voltage detecting circuit 51v, the current detecting circuit 51i, and the adding circuit 54 for outputting a detected signal for an output control of the AC adaptor 10I.

The signal detecting circuit 70 monitors the state of a detected signal to be output to the AC adaptor 10I to detect the state having the possibility of the counter flow. Although the detected signal is set to be higher than the reference voltage by a little at a normal time to perform the output control of the AC adaptor 10I, the detected signal falls to the reference voltage in such a case where the output of the AC adaptor 10I disappears, and consequently the state can be detected by monitoring the detected signal.

Then, by the detection of this state, an operation signal is output to the stopping circuit 72, and the switch circuit SW3 is turned off. The counter flow of a current can be thus prevented.

Moreover, if the operation of the AC adaptor 10I revives in the state in which the switch circuit SW3 is turned off, the input voltage of the set equipment 50I rises, and consequently the voltage detecting circuit 71 detects the rise to output a restart signal to the restarting signal outputting circuit 74. Thereby, the stop resetting circuit 75 releases the operation of the stopping circuit 72, and the switch circuit SW3 is turned on. Thus the original charged state can be restarted.

By this configuration, even in the case where the AC adaptor 10I is taken off from the plug receptacle or an abnormality is caused, the counter flow of the current from the side of the set equipment 50I can be prevented.

### Eleventh Embodiment

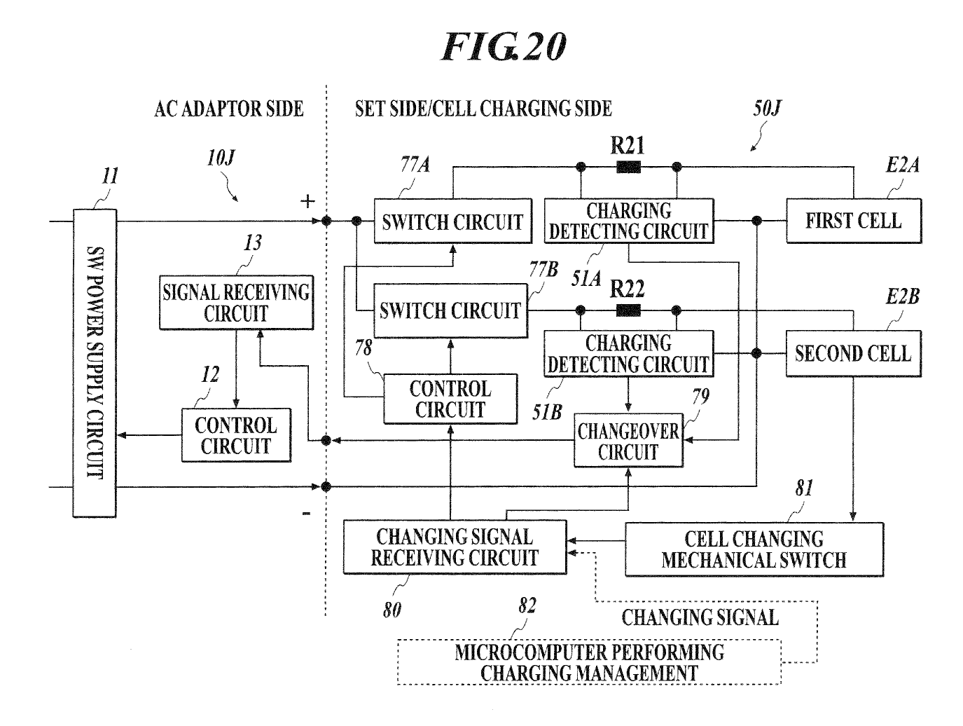

FIG. 20 is a block diagram showing the configuration of the charging system of an eleventh embodiment.

The charging system of the eleventh embodiment is configured for enabling an AC adaptor 10J to perform the charging of a plurality of secondary cells E2A and E2B to a piece of set equipment 50J capable of being mounted with the plurality of secondary cells E2A and E2B being different in type and capacity from each other and having different charging characteristics from each other.

In this embodiment, the same configuration as those of the respective embodiments described above can be applied to the AC adaptor 10J.

The set equipment 50J parallely connects the plurality of secondary cells E2A and E2B with charging detecting circuits 51A and 51B, detecting the charging voltages and charging currents of them, through a plurality of switch circuits 77A and 77B, respectively. Furthermore, the set equipment 50J is provided with a control circuit 78 turning on either of the plurality of switch circuits 77A and 77B selectively, a changeover circuit 79 outputting the detected signal of either of the plurality of charging detecting circuits 51A and 51B selectively to the side of the AC adaptor 10J, and a changing signal receiving circuit making the control circuit 78 and the changeover circuit 79 perform changes corresponding to those of each other.

Secondary cells E2A and E2B are, for example, lithium ion cells or nickel hydrogen cells. Moreover, they may be a plurality of lithium ion cells having capacities different from one another. Moreover, it is also possible to use the cells having the same type and the same capacity.

Set currents and set voltages suitable for the corresponding secondary cells E2A and E2B are set in the plurality of charging detecting circuits 51A and 51B, and charging voltages and charging currents suitable for the respective secondary cells E2A and E2B are supplied by these detected signals.

Moreover, into the changing signal receiving circuit 80 a signal indicating a set cell is input from a cell changing mechanical switch 81 detecting the states of set/unset of the secondary cells in a cell holder, or a change signal indicating a cell that should be charged below the full charge is input from a microcomputer 82 managing the charged state of each cell, and thereby the changing signal receiving circuit 80 is configured to select either of the plurality of secondary cells E2A and E2B as a charging object.

By this charging system, even the set equipment 50J capable of being mounted with the plurality of secondary cells E2A and E2B can perform the charging processing to the secondary cells E2A and E2B one by one to perform the charging of all of the secondary cells E2A and E2B.

In the above, although the optimum embodiments of the present invention have been described, the present invention is not restricted to the first to eleventh embodiments, and the embodiments can be suitably changed without departing from the spirit of the present invention. For example, although the AC adaptors have been exemplified as the power supply devices for charging, the power supply device is not restricted to the AC input power supply devices. Moreover, also as for the charging detecting circuits, they can be configure so as to output a high level signal when a detection voltage or a detection current is lower than a set value, and to output a low level signal when the voltage or the current becomes higher than the set value. In this case, it is preferable to configure the control circuit of the SW power supply circuit so as to lower the output thereof when no detected signals exist, and to heighten the output when a detected signal becomes high. Moreover, the respective characteristic configurations of the first to eleventh embodiments may be suitably combined to be applied to one charging system.

### INDUSTRIAL APPLICABILITY

The present invention can be used for an electronic circuit device including a secondary cell, a power supply device for performing the charging to the secondary cell, and a charging system combining them together.

1-27. (canceled)

28. A charging system, comprising:
an electronic circuit device including a secondary cell; and
a power supply device, being connectable and removable against the electronic circuit device, for supplying electric power for charging to the secondary cell at the time of being connected to the electronic circuit device, wherein:
the electronic circuit device includes:
a charging side detecting circuit for detecting a predetermined parameter indicating a charged state of the secondary cell to output a first detected signal; and
a control signal line for transmitting the first detected signal to the power supply device at the time of being connected to the power supply device,
the power supply device includes:
a power supply circuit capable of changing its output;
a control circuit for controlling the output of the power supply circuit on the basis of the first detected signal; and
a power supply side detecting circuit for detecting an output voltage and/or an output current to output a second detected signal,
and wherein:
the control circuit is configured to control the output on the basis of the second detected signal when the first detected signal is not input.

29. The charging system according to claim 28, wherein:
the control circuit performs a control operation so as to enlarge the power supply output when the first and second detected signal have a reference value, and so as to reduce the power supply output according to displacement quantity when the first or second detected signal is displaced from the reference value by a certain quantity,
the power supply side detecting circuit and the charging side detecting circuit are configured to displace the first or second detected signal from the reference value when the detected voltage exceeds respective set voltages, and
the set voltage of the power supply side detecting circuit is set to be larger than the set voltage of the charging side detecting circuit.

30. The charging system according to claim 28, wherein:
the control circuit is configured so as to enlarge the power supply output when the first and second detected signals are a reference value, and so as to reduce the power supply output according to the displacement quantity when the first or second detected signal is displaced from the reference value by a certain quantity,
the power supply side detecting circuit and the charging side detecting circuit are configured so as to displace the first or second detected signal from the reference value when the detection current exceeds respective set currents, and
the set current of the power supply side detecting circuit is set to be larger than the set current of the charging side detecting circuit.

31. The charging system according to claim 28, wherein
the electronic circuit device further includes:
a plurality of charging side voltage detecting units for detecting a charging voltage to output voltage detected signals on the basis of a plurality of set voltages having different values from one another; and
a first changeover unit for selectively changing any of the voltage detected signals of the plurality of charging side voltage detecting units to transmit the changed voltage detected signal to the power supply device,
the power supply device further includes:
a plurality of power supply side current detecting units for detecting an output current to output current detected signals on the basis of a plurality of set currents having different values from one another;
a second changeover unit for selectively changing any of the current detected signals of the plurality of power supply side current detecting units; and
a control circuit for performing an output control of supplied electric power,
and wherein:
the voltage detected signal and current detected signal that have been changed by the first changeover unit and the second changeover unit, respectively, are transmitted to the control circuit, which performs the output control on the basis of the transmitted voltage and current detected signals.

32. The charging system according to claim 31, wherein:
the power supply device includes an output voltage detecting unit for detecting an output voltage, and
the selective change of the second changeover unit is performed on the basis of a detection result of the output voltage detecting unit.

33. The charging system according to claim 32, wherein:
the second changeover unit performs a change to a current detected signal to reduce the output current when the output voltage is high, and performs a change to a current detected signal to enlarge the output current when the output voltage is low.

34. The charging system according to claim 28, wherein:
the electronic circuit device includes a voltage detecting unit for detecting a charging voltage to output a first detected signal based on a first set voltage;
a current detecting unit for detecting a charging current to output a second detected signal based on a first set current; and
an adding circuit for adding the first detected signal and the second detected signal together to output the added first and second detected signals to the side of the power supply device,
and wherein:
the power supply device further includes:
a voltage detecting unit for detecting an output voltage to output a third detected signal based on a second set voltage;
a current detecting unit for detecting an output current to output a fourth detected signal based on a second set current; and
the control circuit for performing the output control of the supplied electric power,
and wherein:
the control circuit performs the output control on the basis of an addition signal of the detected signals transmitted from the electronic circuit device and the third and fourth detected signals.

35. The charging system according to claim 34, wherein:
the control circuit performs the output control on the basis of the addition signal when the addition signal is input thereinto, or on the basis of the third and fourth detected signals when the addition signal is not input thereinto.

36. The charging system according to claim 35, wherein:
the power supply device further includes:
a signal detecting unit for detecting whether the addition signal is input thereinto or not; and
a changeover circuit for performing a selective change to the addition signal when the signal detecting unit detects that the addition signal has been input thereinto, or a selective change to the third and fourth detected signals when the signal detecting unit detects that the addition signal has not been input thereinto, to transmit the additional signal or the third and fourth detected signals to the control circuit.

37. The charging system according to claim 35, wherein the first set voltage is set to be smaller than the second set voltage, and the first set current is smaller than the second set current.

38. The charging system according to claim 28, wherein the electronic circuit device further includes:
a protecting switch capable of breaking a current from the power supply device to the secondary cell;
a first voltage detecting circuit for detecting a voltage at a node on the side of the secondary cell from the protecting switch to output a first detected signal;
a second voltage detecting circuit for detecting a voltage on the side of the power supply device from the protecting switch to output a second detected signal; and
a changeover circuit for performing a selective change to the first detected signal when the protecting switch is in its on-state or a selective change to the second detected signal when the protecting switch is in its off-state to transmit the changed detected signal to the power supply device.

39. The charging system according to claim 38, wherein:
the second voltage detecting circuit is set so as to output a detected signal to control an output voltage to a voltage higher than a cell voltage of the secondary cell.

40. The charging system according to claim 28, wherein:
the power supply device includes timer unit for performing timing on the basis of an input of a detected signal from the electronic circuit device, and
the power supply device changes a state of the power supply output on the basis of a timing result of the timer unit.

41. The charging system according to claim 28, wherein:
the power supply device includes a display unit for displaying the charged state of the secondary cell.

42. The charging system according to claim 41, wherein:
the electronic circuit device further includes:
a unit for detecting the charged state of the secondary cell; and
a display signal outputting unit for outputting a display signal according to the charged state, and wherein:
the electronic circuit device is configured to enable the display signal outputting unit to transmit the display signal through the control signal line through which the display signal outputting unit outputs the detected signal to the electronic circuit device,
the power supply device includes a display signal detecting circuit detecting the display signal from the control signal line through which the detected signal is transmitted from the electronic circuit device, and
the power supply device makes the display unit operate on the basis of the display signal detected by the display signal detecting circuit.

43. The charging system according to claim 28, wherein:
the electronic circuit device includes a display unit for displaying the charged state of the secondary cell.

44. The charging system according to claim 43, wherein:
the power supply device further includes:
a charged quantity calculating unit for calculating a charged quantity of the secondary cell on the basis of the values of the output voltage and output current thereof;
a unit for giving a predetermined change to the output voltage when a predetermined charged quantity is calculated by the charged quantity calculating unit; and
a display signal transmitting unit for transmitting a display signal through the control signal line through which the electronic circuit device transmits the detected signal when the predetermined charged quantity is calculated by the charged quantity calculating unit,
the electronic circuit device further includes:
a unit for temporarily stopping a charging operation on the basis of a predetermined change of an input voltage; and
a display signal receiving unit for receiving the display signal during the temporary stop,
and wherein:
the electronic circuit device operates the display unit on the basis of the received display signal.

45. The charging system according to claim 28, wherein:
the electronic circuit device further includes:
a plurality of secondary cells connected to an electric power inputting terminal in parallel;
a plurality of switch circuits for turning on and off of respective connections between the electric power inputting terminal and the plurality of secondary cells;
a plurality of detecting circuits for detecting predetermined parameters severally indicating a charged state of each of the plurality of secondary cells to output detected signals on the basis of a set voltage according to each of the secondary cells; and
a changeover circuit for selectively outputting any one of the detected signals of the plurality of detecting circuits to the power supply device,
and wherein:
the charging system is configured so that, if any one of the plurality of secondary cells is selected as a charging object, one of the switch circuits corresponding to the selected secondary cell may be made to be in its on-state, and so that the detected signal of one of the detecting circuits corresponding to the selected secondary cell is output from the changeover circuit.

46. The charging system according to claim 45, wherein:
the electronic circuit device further includes:
a cell holder for holding the plurality of secondary cells in a state of being attachable and detachable; and
a detection mechanism for detecting a state of each of the secondary cells in the cell holder with regard to being mounted or not mounted therein,
and wherein:
the electronic circuit device changes the secondary cell selected as the charging object according to the detected state by the detection mechanism.

47. The charging system according to claim 45, further comprising a microcomputer to manage the charged state of each of the plurality of secondary cells,
and wherein:
the microcomputer changes the charging object to another secondary cell when the secondary cell that is being charged becomes its full charge state.

48. The charging system according to claim 28, wherein:
the predetermined parameter indicating the charged state is any one of or a plurality of a charging voltage, a charging current, a cell voltage at the time of a temporary charging stop.

49. The charging system according to claim 28, wherein:
the first detected signal is an analog signal;
the charging side detecting circuit is configured to displace the first detected signal from a reference value by a predetermined quantity according to a detected value of the parameter; and
the control circuit performs a control operation so as to enlarge a power supply output when the first detected signal is the reference value, and so as to reduce the power supply output according to a displacement quantity when the first detected signal has been displaced from the reference value by a certain quantity.

50. The charging system according to claim 28, wherein:
the electronic circuit device further includes:
a switch circuit serially connected between an electric power inputting terminal and the secondary cell in series;
a signal detecting unit for detecting a detected signal to be output to the power supply device; and
a restart unit for detecting a voltage at an electric power inputting terminal to generate a restart signal,
and wherein:
the electronic circuit device is configured so that the switch circuit may be changed to be off when a magnitude of the detected signal by the signal detecting unit is equal to or less than a predetermined value, and so that the switch circuit may be changed to be on when the restart signal is output from the restart unit.
